(19) United States
(12) Patent Application Publication
(10) Pub. No.: US 2025/0187972 A1
(43) Pub. Date: Jun. 12, 2025

(54) PHASE SEPARATED GLASSES

(71) Applicant: CORNING INCORPORATED, CORNING, NY (US)

(72) Inventors: Venkatesh Botu, Corning, NY (US); Ling Cai, Painted Post, NY (US); Heath Aaron Filkins, Corning, NY (US); Lisa Ann Lamberson, Painted Post, NY (US); Aize Li, Painted Post, NY (US); Charlene Marie Smith, Corning, NY (US); Liping Xiong Smith, Painted Post, NY (US)

(21) Appl. No.: 18/847,431

(22) PCT Filed: Mar. 27, 2023
(86) PCT No.: PCT/US2023/016366

§ 371 Date: Sep. 16, 2024

Related U.S. Application Data
(60) Provisional application No. 63/326,308, filed on Apr. 1, 2022.

(51) Int. Cl. C03C 3/093; C03B 17/06; C03C 3/095; C03C 15/00

(52) U.S. Cl. CPC C03C 3/093; C03C 3/095; C03C 15/00; C03B 17/06

(57) ABSTRACT

A method of making a glass article using a phase separated silicate glass including a silica rich first phase and a boron rich second phase. The phase separated silica glass is etched with an etchant to remove at least a portion of the second phase and obtain a high silica content porous glass article. The porous glass article may be heat treated to consolidate the porous glass article to close the pores of the porous glass article and obtain a consolidated glass article with very low dielectric properties. Various glass compositions are disclosed that phase separate via spinodal decomposition.

### CROSS-REFERENCE TO RELATED APPLICATIONS

This application claims the benefit of priority under 35 U.S.C. § 119 of U.S. Provisional Application Ser. No. 63/326,308 filed on Apr. 1, 2022, the content of which is relied upon and incorporated herein by reference in its entirety.

### FIELD

The disclosure generally relates to phase separated glasses having at least two distinct glass phases. Phase separated glasses disclosed herein may be fusion formable and may be further processed to provide glass articles with very low dielectric constants and loss tangents.

### BACKGROUND

Digital technologies continue to expand, particularly in terms of data connectivity and processing rates. For example, processing rates on the order of 1 Gbits/s are expanding to rates on the order of tens of Gbits/s. The corresponding electronic device technology to achieve these data rates likely will result in an expansion of signal transmission and receiving frequencies on the order of 1 GHz to the order of 10 GHz, even up to about 100 GHz, in some cases.

As these signal frequencies increase to accommodate an increase in data processing rates, the technical specifications and requirements relating to absorption loss associated with the insulating materials employed in these devices take on greater importance. While there are materials available having low loss tangents at frequencies greater than 10 GHz, the processing characteristics of these materials can limit their ability to be manufactured using certain forming processes.

There are commercially available materials used as insulating layers in PCBs. For example, one common glass-epoxy laminate used as an insulating layer in PCB applications has a loss tangent of 0.0058 at signal frequencies of 10 GHz. However, this insulating laminate has a limiting loss tangent as the industry moves to higher and higher signal frequencies. Other laminates, such as fused silica/polymer laminates, have been found that exhibit low loss characteristics at frequencies of 10 GHz or more. However, the mechanical properties of the fused silica and polymer layer limit the use of these laminates in some processes, as the fused silica layer may crack during post processing.

Materials such as Radome pyroceramic, high purity fused silica, sapphire, alumina and silica, may have low loss tangents at frequencies greater than 10 GHz. However, these materials may have such high viscosities at forming temperatures that their ability to be processed using standard sheet forming processes, such as slot-draw and overflow down draw, may be limited. There are also alkali-free glass and glass-ceramic materials which have low loss tangents at frequencies greater than 10 GHz, examples of which include B₂O₃—P₂O₅—SiO₂ ternary (BPS) and MgO—Al₂O₃—SiO₂ (MAS) systems. However, these systems typically have a liquidus viscosity too low for common forming methods.

### SUMMARY

A method of making a glass article is disclosed comprising forming a molten glass, the molten glass undergoing spinodal decomposition to produce a phase separated molten glass comprising a first phase, a second phase, and a total SiO₂ content in a range from about 59 mol % to about 69 mol % and a B₂O₃ content in a range from about 9 mol % to about 20 mol %, drawing the phase separated molten glass into a glass sheet, and exposing the glass sheet to a first acid solution at a temperature in a range from about 60° C. to about 95° C. for a time in a range from about 16 hours to about 24 hours to remove at least a portion of the second phase from the glass sheet and obtain a porous glass sheet comprising a total silica content greater than about 95 mol %, the first acid solution comprising about 5 wt % to about 40 wt % of an inorganic acid or an organic acid. For example, the first acid solution may comprise at least one of HCl, H₂SO₄, HNO₃, HF, or H₃PO₄. In aspects, the first acid solution may comprise at least one of citric acid or acetic acid

A calculated open porosity of the porous glass sheet may be greater than about 28%.

In some aspects, the first acid solution may comprise HCl, for example about 5 wt % HCl.

The method may comprise heat treating the porous glass sheet at a temperature in a range from about 500° C. to about 700° C. for a time in a range from about 45 minutes to about 75 minutes.

In aspects, the method may comprise heating the porous glass sheet to a temperature in a range from about 900° C. to about 1100° C. for a time in a range from about 1 hour to about 24 hours to consolidate the porous glass sheet and obtain a consolidated glass sheet, the consolidated glass sheet comprising a dielectric constant Dₖ less than about 4.0 when measured at 10 GHz using a split post dielectric resonator.

In aspects, Dₖ of the consolidated glass sheet may be less than about 3.5.

In aspects, the consolidated glass sheet may comprise a loss tangent D_{f} less than about 0.0075 when measured at 10 GHz using a split post dielectric resonator.

In some aspects, the consolidation temperature is equal to or greater than about 1000° C., and wherein the consolidated glass sheet may comprise a loss tangent D_{f} less than about 0.003 when measured at 10 GHz using a split post dielectric resonator. In some aspects, D_{f} may be less than about 0.001 when measured at when measured at 10 GHz using a split post dielectric resonator.

The method may further comprise exposing the porous glass sheet to a second acid solution comprising HF for a period of 1 minute to 15 minutes prior to the heat treating.

In aspects, the drawing the molten glass into the glass sheet may comprise flowing the molten glass over converging forming surfaces of a forming body as separate streams of molten glass, the separate streams of molten glass joining along a bottom edge of the forming body. In some aspects, the drawing may comprise flowing the molten glass from a slot positioned in a bottom of a vessel.

In aspects, a glass article is described comprising a spinodally decomposed glass including a first phase and a second phase, the glass comprising on an oxide basis SiO₂ from about 57 mol % to about 70 mol %, Al₂O₃ from about 4.7 mol % to about 10.5 mol %, B₂O₃ from about 11.2 mol % to about 15.2 mol %, ZnO from about 1.2 mol % to about 7.4 mol %, and one or more alkaline earth oxides (RO) totaling from about 3.7 mol % to about 20 mol %, wherein RO is selected from MgO, CaO, SrO, and BaO.

The glass may comprise SnO from about 0.09 mol % to about 0.15 mol %.

In aspects, the glass may comprise MgO from about 1.5 mo % to about 9.6 mol %.

In aspects, MgO/ZnO may be from about 0 to about 3.7.

In aspects, B₂O₃/ZnO may be from about 1.6 to about 12.6

A dielectric constant Dₖ of the glass may be from about 4.5 to about 6.3.

A loss tangent D_{f} of the glass may be from about 0.002 to about 0.005.

In aspects, the glass article may comprise at least one of La₂O₃, Y₂O₃, or Li₂O in an amount less than about 3.0 mol %.

In aspects, the glass article may comprise CaO from about 0.05 mol % to about 4.8 mol %.

In other aspects, a glass article is disclosed comprising a spinodally decomposed glass including a first phase and a second phase, the glass comprising on an oxide basis SiO₂ from about 59 mol % to about 69 mol %, Al₂O₃ from about 3 mol % to about 13 mol %, B₂O₃ from about 9.8 mol % to about 20 mol %, and one or more alkaline earth oxides (RO) totaling from about 3.9 mol % to about 11.5 mol %, wherein RO is selected from MgO, CaO, SrO, and BaO.

In aspects, B₂O₃/(Al₂O₃+SiO₂) of the glass may be from about 0.12 to about 0.3.

In aspects, the glass may comprise SiO₂ in a range from about 68.0 mol % to about 69.0 mol %.

A dielectric constant Dₖ of the glass may be from about 4.7 to about 5.4.

A loss tangent D_{f} of the glass may be from about 0.002 to about 0.004.

In still other aspects, a glass sheet is described comprising SiO₂ greater than 95% mol %, Al₂O₃ less than 1 mol %, B₂O₃ less than about 3 mol %, and less than about 0.5 mol % total alkaline earth oxides (RO), wherein RO is selected from MgO, CaO, SrO, and BaO.

The glass sheet can comprise a width greater than about 340 mm and a length greater than about 440 mm, for example a width greater than about 680 mm and a length greater than about 880 mm, or a width is greater than about 1500 mm and the length is greater than about 1800 mm.

In some aspects, the glass sheet comprises a loss tangent D_{f} less than about 0.005 when measured at 10 GHz using a split post dielectric resonator, for example less than about 0.004, less than about 0.003, less than about 0.002, or less than about 0.001 when measured at 10 GHz. The glass sheet may comprise a dielectric constant less than about 4.0 when measured at 10 GHz using a split post dielectric resonator.

In aspects, the glass sheet may be a porous glass sheet with an open porosity greater than 28%. Pores of the porous glass sheet with a diameter greater than 3 nm may constitute less than about 8.7% of the total pores of the glass sheet when measured by mercury intrusion. A median d50 pore diameter of pores of the porous glass sheet May be less than about 0.05 μm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a schematic drawing of an exemplary fusion downdraw glass manufacturing apparatus;

FIG. 2 is a photo of an exemplary phase separated glass in accordance with the present disclosure;

FIG. 3 is a plot representing x-ray diffraction (XRD) data showing no crystallization in the glass, verifying the phase separation is between two glass phases;

FIG. 4 is a plot showing optical transmission for two glasses, a commercially available, non-phase separated glass (Corning Eagle XG) and an exemplary phase separated glass, as a function of wavelength;

FIG. 5 is a plot showing reflectance between Corning Eagle XG and the exemplary phase separated glass of FIG. 4 as a function of wavelength;

FIG. 6 is (a) a strain scope image of an as-drawn sample of the exemplary phase separated glass of FIG. 4 and (b) an SEM image of the exemplary phase separated glass;

FIG. 7 is (a) a strain scope image of the exemplary phase separated glass sample of FIG. 4 after heat treatment at 720° C. for 2 hours and (b) an SEM image of the exemplary phase separated glass after the heat treatment;

FIG. 8 is (a) a strain scope image of the exemplary phase separated glass sample of FIG. 7 after a second heat treatment at 720° C. for 2 hours and (b) an SEM image of the same exemplary phase separated glass sample after the second heat treatment;

FIG. 9 is an SEM image of a sample of the exemplary phase separated glass of FIG. 4 after heat treatment at 745° C. for 24 hours;

FIG. 10 is an SEM image of a sample of the exemplary phase separated glass of FIG. 4 after heat treatment at 800° C. for 24 hours;

FIG. 11 is an SEM image of a sample of the exemplary phase separated glass of FIG. 4 after heat treatment at 850° C. for 24 hours;

FIG. 12 is an SEM image of a sample of the exemplary phase separated glass of FIG. 4 after heat treatment at 900° C. for 24 hours;

FIG. 13 is schematic representation of a coordinate system used to evaluate the Fourier transform of data from a phase separated glass;

FIG. 14 is two-dimensional Fourier transform (2DFT) corresponding to a sample measured from an x surface;

FIG. 15 are Fourier transform data for three surfaces of an exemplary phase separated glass sample plotted in an rθ coordinate system, where (a) represents the x cross-section, (b) represents the y cross-section, and (c) represents the z cross-section;

FIG. 16 is a plot showing corner stress in the glass sheet of FIG. 16 as the glass composition was transitioned during the manufacturing process from a commercially available glass (Corning Eagle XG) to an exemplary phase separated glass, and showing a gradual increase in stress over the transition period;

FIG. 17 is a schematic representation of a glass sheet showing points along the edge portions of the glass sheet where stress measurements for FIG. 16 were obtained;

FIG. 18 is a plot showing the loss tangent of exhibited by glass formed from a commercially available non-phase separable glass composition to an exemplary phase separable glass composition as a function of time and shows a gradual decrease in loss tangent;

FIG. 19 is a plot showing stress in a glass sheets produced from molten glass as the ratio (B2O3+MgO)/CaO (calculated with wt %) in the molten glass varied during a transition from a commercially available non-phase separable glass composition to an exemplary phase separable glass composition as a function of time;

FIG. 20 is a plot of dielectric constant as a function of replacement of MgO with ZnO for an exemplary phase separated glass;

FIG. 21 is a plot of loss tangent as a function of replacement of MgO with ZnO for the exemplary phase separated glass of FIG. 20;

FIG. 22 is a plot of dielectric constant as a function of replacement of MgO with ZnO for an exemplary phase separated glass as a function of total RO (or R₂O) in exemplary phase separated glass with ZnO replacing B₂O₃;

FIG. 23 is a plot of loss tangent as a function of replacement of MgO with ZnO for the exemplary phase separated glass of FIG. 22 as a function of total RO (or R₂O) in exemplary phase separated glass with Zn replacing B₂O₃;

FIG. 24 is a plot of resistivity as a function of temperature (° C.) for GS57 and GS17 resistivity;

FIG. 25 is a plot of dielectric constant as a function of mol % La₂O₃ when La₂O₃ is substituted for BaO in glass composition GS72;

FIG. 26 is a plot of loss tangent as a function of mol % La₂O₃ when La₂O₃ is substituted for Ba in glass composition GS72;

FIG. 27 is a plot of dielectric constant as a function of mole % La₂O₃ or Y₂O₃ when added to an Sr—Ba containing alumino-borosilicate glass;

FIG. 28 is a plot of loss tangent as a function of mole % La₂O₃ or Y₂O₃ when added to an Sr—Ba containing alumino-borosilicate glass;

FIG. 29 is a plot of Dₖ at 10 GHz as a function of mol % transition metal oxide when added as a replacement for CaO in glass composition GS17;

FIG. 30 is a plot of D_{f} at 10 GHz as a function of mol % transition metal oxide when added as a replacement for CaO in glass composition GS17;

FIG. 31 is a plot of Dₖ at 10 GHz as a function of mole % F— when added as a replacement for B₂O₃; and

FIG. 32 is a plot of D_{f} at 10 GHz as a function of mole % F— when added as a replacement for B₂O₃.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise specified, all compositions are expressed in terms of as-batched (i.e., constituent content) mole percent (mol %). As will be understood by those having ordinary skill in the art, various melt constituents (e.g., fluorine, alkali metals, boron, etc.) may be subject to different levels of volatilization (e.g., as a function of vapor pressure, melt time and/or melt temperature) during melting of the constituents. As such, the term “about,” in relation to such constituents, is intended to encompass values within about 1 mol % when measuring final articles as compared to the as-batched compositions provided herein. With the forgoing in mind, substantial compositional equivalence between final articles and as-batched compositions is expected.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, and/or the number or type of embodiments described in the specification.

The concentration of constituent components of glass compositions described herein (e.g., SiO₂, Al₂O₃, and the like) are given in mole percent (mol. %) on an oxide basis, unless otherwise specified.

A variety of processes may be used to form glass articles described herein including, without limitation, fusion processes, slot-draw processes, and float glass processes.

As used herein, the singular forms “a,” “an” and “the” include plural referents unless the context clearly dictates otherwise. Thus, for example, reference to a “component” includes aspects having two or more such components, unless the context clearly indicates otherwise.

The term “CTE,” as used herein, refers to the coefficient of thermal expansion of a glass material, element or the like in the disclosure as averaged over a temperature range from about 20° C. to about 300° C., unless otherwise specified.

The term “dielectric constant (Dₖ)” refers to the dielectric constant of a glass structure, design, or article of the disclosure.

The term “loss tangent” in this disclosure to refers to the inherent dissipation of electromagnetic energy (e.g., heat) afforded by a particular glass, layer, or laminated structure associated with aspects of this disclosure. The lower the dielectric loss (e.g., portion of energy lost as heat), the more effective the dielectric material is. The loss tangent can be parameterized in terms of either the loss angle δ or the corresponding loss tangent tan δ. Permittivity is the ability of a substance, such as glasses of the disclosure, to store electrical energy in the presence of an external electric field. Further, the terms “permittivity” and “dielectric constant (Dₖ)” are used interchangeably within this disclosure. The dielectric constant is a quantity measuring the ability of a substance to store electrical energy in an electric field. Permittivity is a complex quantity because it describes the phase and magnitude of polarization in relation to an oscillating field. The terms “dielectric constant (Dₖ)” and “relative permittivity (εᵣ)” are used interchangeably in the disclosure and are defined as the ratio between the real part of the complex permittivity (absolute permittivity) and the permittivity of free space (vacuum permittivity). Materials with an εᵣ>1 are considered to be dielectric materials and poor conductors of electricity. Materials with low dielectric constants can withstand more intense electrostatic fields without having a dielectric breakdown. Dielectric breakdown results in the material conducting a current which, in most solid materials, can result in damage to the material. The “loss tangent” is expressed as the ratio between the imaginary and real part of the complex permittivity. In general, the dielectric constant and loss tangent of a material are dependent on the frequency of the external field. Therefore, the dielectric property measured in the kHz range may not represent the dielectric property at microwave frequencies. Further, unless otherwise noted, the “loss tangent” and “dielectric constant (Dₖ)” attributes of the glasses of the disclosure can be measured at frequencies of 1 GHz or greater according to a split post dielectric resonator (SPDR) or an open-cavity resonator configuration according to techniques as understood by those with ordinary skill in the field of the disclosure. The particular method chosen can be selected based on the sample thickness and its lateral dimensions.

As used herein, molten glass refers to a molten material formed by heating batch materials in a melting vessel, that, when cooled, may form a glass. “Molten glass” has a viscosity in a range from about 1 kPoise to about 200 kPoise.

As used herein, spinodal decomposition refers to a phase transformation in which a material, e.g., a glass material, having a single thermodynamic phase separates, for example spontaneously, into multiple coexisting but separate phases, for example two phases, without nucleation. The separate phases may be dispersed through the glass, e.g., intertwined. The separate phases my exist in approximately equal proportions and occupy approximately equal volumes. Accordingly, the term “phase separated glass,” as used herein, refers to a glass that has undergone spinodal decomposition to produce a glass with at least two stable, intertwined phases, wherein the interconnected second phase is dispersed throughout the interconnected first phase. One phase (e.g., the first or primary phase) may be enriched with a first chemical species (e.g., SiO₂) and the second (e.g., secondary) phase may be enriched with a second chemical species (e.g., B₂O₃). That is, the first phase may, for example, include predominately all the SiO₂, while the second phase includes predominately all the B₂O₃.

As used herein, consolidation (e.g., to consolidate) refers to a process by which a porous material is subjected to heating conditions appropriate to bring the material to at least a softening temperature, e.g., a melting temperature, whereby the pores of the porous material close and the material ceases to be porous and becomes a solid article, e.g., a solid glass article without pores distributed throughout. For example, the heating condition may be a temperature greater than the glass transition temperature Tg of the material.

Glasses and glass articles of the present disclosure may be suitable for electronic devices, electronic device substrates, and other comparable applications that enable higher frequency communication in devices without a significant reduction in performance as it relates to other non-electrical device requirements. For instance, as higher frequency communication signals are used in these devices, the signals must pass through various physical barriers that otherwise attenuate or block these signals. As such, glasses and/or glass articles of the present disclosure can be well-suited for use as these barriers. Examples of these physical barriers include electrically insulating substrates used in the fabrication of electronic circuits and signal transmission structures, device covers, and other related structures that can be employed to house circuits and other electronic device components employed in electronic devices operating at high signal frequencies.

In some embodiments, glasses of the present disclosure may be suitable for use as substrates in printed circuit boards (PCBs). A PCB typically includes an insulating layer laminated with a copper film. In some implementations, glasses of the present disclosure can be characterized by a low loss tangent and mechanical properties suitable for use as the insulating layer in a PCB, optionally in combination with one or more polymeric substrate layers. Optionally, glasses of the present disclosure can be substantially free of alkali metals to decrease the likelihood of ion migration during processing.

Some aspects of the present disclosure also relate to glasses having properties suitable for manufacturing, and in particular suitable for forming processes such as slot-draw processes and overflow fusion drawing processes, for example. The fusion draw process is an industrial technique that has been used for large-scale manufacture of thin glass sheets, e.g., sheets having a thickness less than about 3 mm, for example less than about 1 mm, less than about 0.7 mm, or even less than about 0.1 mm. Compared to other flat glass manufacturing techniques, such as the float or slot draw processes, the fusion draw process yields thin glass sheets with high flatness and surface quality. As a result, the fusion draw process is often a dominant manufacturing technique in the fabrication of thin glass substrates (e.g., for liquid crystal displays, as well as for cover glass for various personal electronic devices).

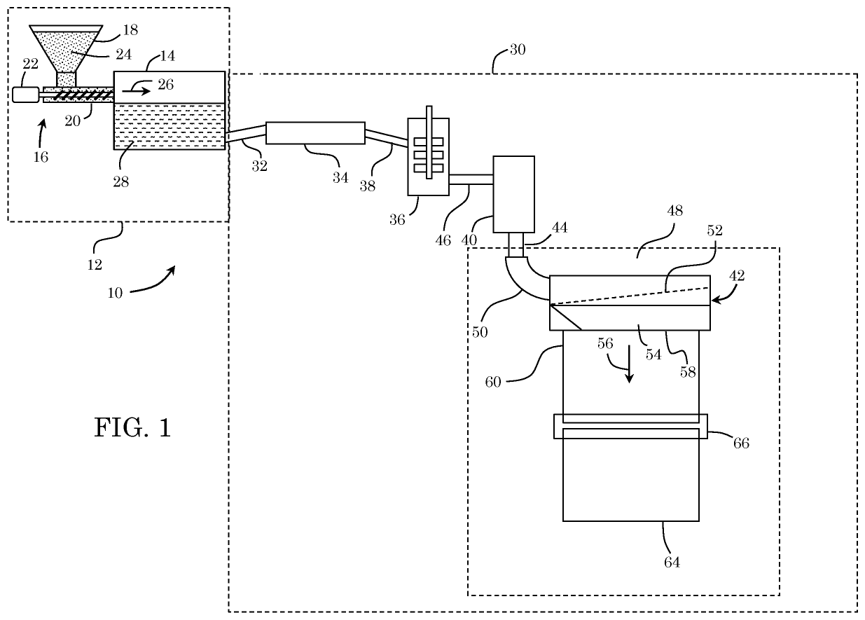

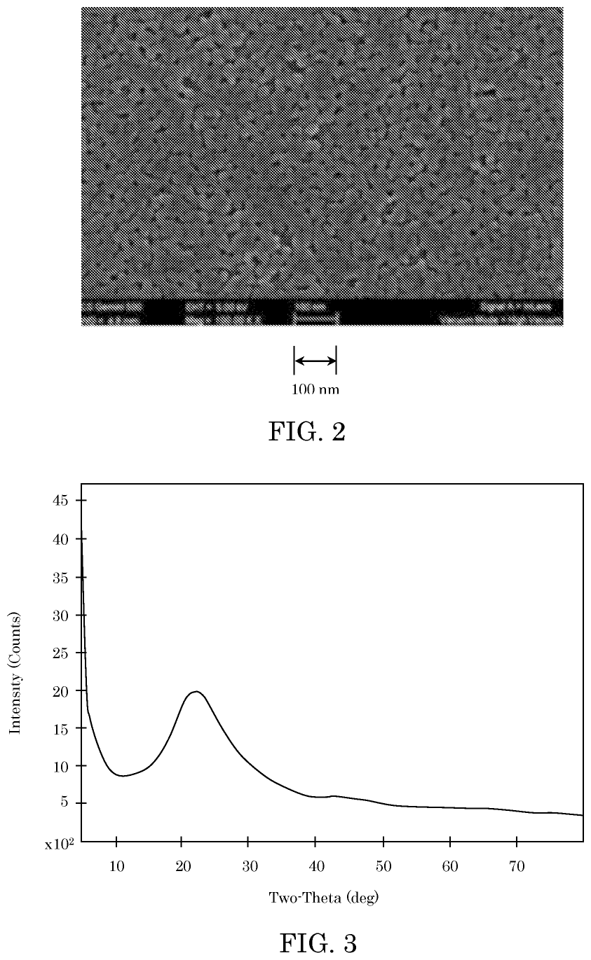

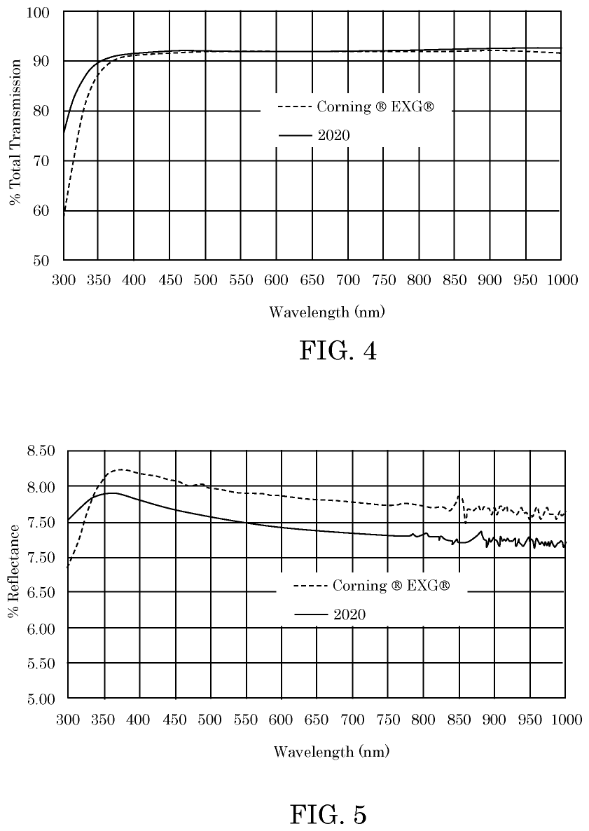

Shown in FIG. 1 is an exemplary glass manufacturing apparatus 10. Glass manufacturing apparatus 10 comprises a glass melting furnace 12 including a melting vessel 14. In addition to melting vessel 14, glass melting furnace 12 may optionally include one or more additional components such as heating elements (e.g., combustion burners and/or electrodes) configured to heat raw material and convert the raw material into a molten material, hereinafter, molten glass. For example, melting vessel 14 may be an electrically boosted melting vessel, wherein energy is added to the raw material through both combustion burners and by direct heating, wherein an electrical current is passed through the raw material, the electrical current thereby adding energy via Joule heating of the raw material.

Glass melting furnace 12 may include other thermal management devices (e.g., thermal insulation components) that reduce heat loss from the melting vessel. Glass melting furnace 12 may include electronic and/or electromechanical devices that facilitate melting of the raw material into a glass melt. Glass melting furnace 12 may include support structures (e.g., support chassis, support member, etc.) or other components.

Melting vessel 14 can be formed from a refractory material, for example a refractory ceramic material comprising alumina or zirconia, although the refractory ceramic material can comprise other refractory materials, such as yttrium (e.g., yttria, yttria-stabilized zirconia, yttrium phosphate), zircon (ZrSiO₄) or alumina-zirconia-silica or even chrome oxide, used either alternatively or in any combination. In some examples, melting vessel 14 may be constructed from refractory ceramic bricks.

Glass melting furnace 12 may be incorporated as a component of a glass manufacturing apparatus configured to fabricate a glass article, for example a glass ribbon, although the glass manufacturing apparatus can be configured to form other glass articles without limitation, such as glass rods, glass tubes, glass envelopes (for example, glass envelopes for lighting devices, e.g., light bulbs), and glass lenses. In some examples, glass melting furnace 12 may be included in a glass manufacturing apparatus comprising a slot draw apparatus, a float bath apparatus, a down-draw apparatus (e.g., a fusion down-draw apparatus), an up-draw apparatus, a pressing apparatus, a rolling apparatus, a tube drawing apparatus, or any other glass manufacturing apparatus that would benefit from the present disclosure. By way of example, FIG. 1 schematically illustrates glass melting furnace 12 as a component of a fusion down-draw glass manufacturing apparatus 10 for fusion drawing a glass ribbon for subsequent processing into individual glass sheets or rolling the glass ribbon onto a spool. As used herein, fusion drawing comprises flowing molten glass over inclined, e.g., converging, side surfaces of a forming body, wherein the resulting streams of molten material join, or “fuse,” at the bottom of the forming body to form a glass ribbon.

Glass manufacturing apparatus 10 may optionally include an upstream glass manufacturing apparatus 16 positioned upstream of melting vessel 14. In some examples, a portion of, or the entire upstream glass manufacturing apparatus 16, can be incorporated as part of the glass melting furnace 12.

As shown in FIG. 1, upstream glass manufacturing apparatus 16 may include a raw material storage bin 18, a raw material delivery device 20, and a motor 22 connected to raw material delivery device 20. Raw material storage bin 18 may be configured to store raw material 24 that can be fed into melting vessel 14 of glass melting furnace 12 through one or more feed ports, as indicated by arrow 26. Raw material 24 typically comprises one or more glass forming metal oxides and one or more modifying agents. In some examples, raw material delivery device 20 may be powered by motor 22 to deliver a predetermined amount of raw material 24 from raw material storage bin 18 to melting vessel 14. In further examples, motor 22 may power raw material delivery device 20 to introduce raw material 24 at a controlled rate based on a level of molten glass sensed downstream from melting vessel 14 relative to a flow direction of the molten glass. Raw material 24 within melting vessel 14 can thereafter be heated to form molten glass 28. Typically, the raw material is added to the melting vessel as particulate, for example as various “sands.” Raw material 24 may also include scrap glass (i.e., cullet) from previous melting and/or forming operations. Combustion burners may be used to begin the melting process. In an electrically boosted melting process, once the electrical resistance of the raw material is sufficiently reduced by the combustion burners, electric boost can begin by developing an electrical potential between electrodes positioned in contact with the raw material, thereby establishing an electrical current through the raw material, the raw material typically entering, or in, a molten state.

Glass manufacturing apparatus 10 may also include a downstream glass manufacturing apparatus 30 positioned downstream of glass melting furnace 12 relative to a flow direction of molten glass 28. In some examples, a portion of downstream glass manufacturing apparatus 30 may be incorporated as part of glass melting furnace 12. For instance, first connecting conduit 32 discussed below, or other portions of the downstream glass manufacturing apparatus 30, may be incorporated as part of the glass melting furnace 12.

Downstream glass manufacturing apparatus 30 may include a first conditioning chamber, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. Accordingly, first connecting conduit 32 provides a flow path for molten glass 28 from melting vessel 14 to fining vessel 34. However, other conditioning chambers may be positioned downstream of melting vessel 14, for example between melting vessel 14 and fining vessel 34. In some embodiments, a conditioning chamber may be employed between the melting vessel and the fining chamber. For example, molten glass from a primary melting vessel can be further heated in a secondary melting (conditioning) vessel or cooled in the secondary melting vessel to a temperature lower than the temperature of the molten glass in the primary melting vessel before entering the fining chamber.

Bubbles may be removed from molten glass 28 by various techniques. For example, raw material 24 may include multivalent compounds (i.e., fining agents) such as tin oxide that, when heated, undergo a chemical reduction reaction and release oxygen. Other suitable fining agents can include without limitation arsenic, antimony, iron, and/or cerium, although the use of arsenic and antimony, owing to their toxicity, may be discouraged for environmental reasons in some applications. Fining vessel 34 is heated, for example to a temperature greater than the melting vessel interior temperature, thereby heating the fining agent to a sufficient reaction temperature for chemical reduction. Oxygen produced by the temperature-induced chemical reduction of one or more fining agents included in the molten glass can diffuse into gas bubbles produced during the melting process. The enlarged gas bubbles with increased buoyancy then rise to a free surface of the molten glass within the fining vessel and are thereafter vented from the fining vessel, for example through a vent tube in fluid communication with the atmosphere above the free surface.

Downstream glass manufacturing apparatus 30 may further include another conditioning chamber, such as mixing apparatus 36, for example a stirring vessel, for mixing the molten glass that flows downstream from fining vessel 34. Mixing apparatus 36 can be used to provide a homogenous glass melt composition, thereby reducing chemical and/or thermal inhomogeneities that may otherwise exist within the molten glass exiting the fining vessel. As shown, fining vessel 34 may be coupled to mixing apparatus 36 by way of a second connecting conduit 38. Accordingly, molten glass 28 can be gravity fed from the fining vessel 34 to mixing apparatus 36 through second connecting conduit 38. Typically, the molten glass within mixing apparatus 36 includes a free surface, with a free (e.g., gaseous) volume extending between the free surface and a top of the mixing apparatus. While mixing apparatus 36 is shown downstream of fining vessel 34 relative to a flow direction of molten glass 28, mixing apparatus 36 may be positioned upstream from fining vessel 34 in other embodiments.

Downstream glass manufacturing apparatus 30 may include multiple mixing apparatus, for example a mixing apparatus upstream from fining vessel 34 and a mixing apparatus downstream from fining vessel 34. When used, multiple mixing apparatus may be of the same design, or they may be of a different design from one another. One or more of the vessels and/or conduits disclosed herein may include static mixing vanes positioned therein to further promote mixing and subsequent homogenization of the molten material.

Downstream glass manufacturing apparatus 30 may further include another conditioning chamber such as delivery vessel 40 located downstream from mixing apparatus 36. Delivery vessel 40 can act as an accumulator and/or flow controller to provide a consistent flow of molten glass 28 to forming body 42 by way of exit conduit 44. The molten glass within delivery vessel 40 can, in some embodiments, include a free surface, wherein a free volume extends upward from the free surface to a top of the delivery vessel. As shown, mixing apparatus 36 can be coupled to delivery vessel 40 by way of third connecting conduit 46, wherein molten glass 28 can be gravity fed from mixing apparatus 36 to delivery vessel 40 through third connecting conduit 46.

Downstream glass manufacturing apparatus 30 may further include forming apparatus 48 configured to form a glass article, for example glass ribbons. Accordingly, forming apparatus 48 may comprise a down-draw apparatus, such as an overflow down-draw (e.g., fusion) apparatus, wherein exit conduit 44 is positioned to deliver molten glass 28 from delivery vessel 40 to inlet conduit 50 of forming body 42. The forming body in a fusion down-draw glass manufacturing apparatus can comprise a trough 52 positioned in an upper surface of the forming body and opposing converging forming surfaces 54 that converge in a draw direction 56 along a bottom edge (root) 58 of the forming body. Molten glass delivered to forming body trough 52 via delivery vessel 40, exit conduit 44, and inlet conduit 50 overflows the walls of trough 52 and descends along the converging forming surfaces 54 as separate flows of molten glass. The separate flows of molten glass join below and along the root 58 to produce a ribbon of molten glass that is drawn in draw direction 56 from root 58 by applying a downward tension to the molten glass ribbon, such as by gravity and opposing, counter-rotating pulling rolls 62. The applied downward tension, and the temperature of the molten glass, can be used to control dimensions of the glass ribbon as the molten glass cools and a viscosity of the molten glass increases. Accordingly, the molten glass ribbon goes through a viscosity transition, from a viscous state to a viscoelastic state, to an elastic state and acquires mechanical properties that give glass ribbon 60 stable dimensional characteristics. Glass ribbon 60 may then be scored, then divided into shorter lengths, such as into glass sheets 64 using scoring apparatus 66.

Components of downstream glass manufacturing apparatus 30, including any one or more of connecting conduits 32, 38, 46, fining vessel 34, mixing apparatus 36, delivery vessel 40, exit conduit 44, or inlet conduit 50 may be formed from a precious metal. Suitable precious metals include platinum group metals selected from the group consisting of platinum, iridium, rhodium, osmium, ruthenium and palladium, or alloys thereof. For example, downstream components of the glass manufacturing apparatus may be formed from a platinum-rhodium alloy including from about 70% to about 90% by weight platinum and about 10% to about 30% by weight rhodium.

To facilitate fusion draw processing, a glass desirably has a sufficiently high liquidus viscosity (i.e., the viscosity of a molten glass at the liquidus temperature). A high liquidus viscosity can facilitate forming of the glass by down-draw process, such as fusion forming. Liquidus viscosities of fusion formable glasses may be greater than about 140 kPoise. In addition, the fusion drawing process can operate over a range of viscosities. Glass is typically delivered to the trough of the forming body at a viscosity corresponding to about 20,000-35,000 Poise and leaves the root of the forming body as a viscous ribbon at a viscosity corresponding to about 100,000 Poise or more. The temperature corresponding to a 35,000 Poise viscosity is often used as a guide for the temperature at which glass is to be delivered to the trough of the forming body for fusion drawing. Glasses of the present disclosure can have a temperature corresponding to a 35,000 Poise Temperature (referred to herein as the “35,000 Poise Temperature”) that facilitates forming through down-draw processes, for example greater than about 1250° C. Typically, a low 35,000 Poise Temperature is desired to minimize undesirable creep of the forming body refractory material over time.

The temperature corresponding to a 200 Poise viscosity is often used as a guideline for a suitable melting temperature for a glass. In some implementations, glasses of the present disclosure may be characterized by a high 200 Poise Temperature, also referred to as a Poise Melting Point (referred to herein as the “200 Poise Melting Point”), to facilitate forming. Preferably, the difference between the 200 Poise Temperature and the 35,000 Poise Temperature is less than or equal to about 450° C., for example equal to or less than about 420° C., such as equal to or less than about 400° C.

Phase separated glasses of the present disclosure may comprise a total amount of SiO₂ in a range from about 57 mol % to about 71 mol %, for example in a range from about 59 mol % to about 68 mol %, in a range from about 59 mol % to about 67 mol %, in a range from about 59 mol % to about 66 mol %, in a range from about 59 mol % to about 65 mol %, in a range from about 59 mol % to about 64 mol %, in a range from about 59 mol % to about 63 mol %, in a range from about 59 mol % to about 62 mol %, in a range from about 59 mol % to about 61 mol %, in a range from about 59 mol % to about 61 mol %, in a range from about 59 mol % to about 60 mol %, in a range from about 60 mol % to about 69 mol %, in a range from about 61 mol % to about 69 mol %, in a range from about 62 mol % to about 69 mol %, in a range from about 63 mol % to about 69 mol %, in a range from about 64 mol % to about 69 mol %, in a range from about 65 mol % to about 69 mol %, in a range from about 66 mol % to about 69 mol %, in a range from about 67 mol % to about 69 mol %, in a range from about 68 mol % to about 69 mol %, including all ranges and subranges therebetween. In some embodiments, glasses of the present disclosure may comprise a total amount of SiO₂ in a range from about 67 mol % to about 71 mol %, for example in a range from about 67.2 mol % to about 69 mol %, in a range from about 67.4 mol % to about 69 mol %, in a range from about 67.6 mol % to about 69 mol %, in a range from about 67.8 mol % to about 69 mol %, in a range from about 68.0 mol % to about 69 mol %, in a range from about 68.2 mol % to about 69 mol %, in a range from about 68.4 mol % to about 69 mol %, in a range from about 68.6 mol % to about 69 mol %, in a range from about 68.8 mol % to about 69 mol %, in a range from about 67 mol % to about 68.6 mol %, in a range from about 67 mol % to about 68.4 mol %, in a range from about 67 mol % to about 68.2 mol %, in a range from about 67 mol % to about 68.0 mol %, in a range from about 67 mol % to about 67.8 mol %, in a range from about 67 mol % to about 67.6 mol %, in a range from about 67 mol % to about 67.4 mol %, including all ranges and subranges therebetween. As used herein, the term “total amount” in the context of a phase separated glass refers to the amount of a chemical species in the phase separated glass without regard to the location of the chemical species in any of the individual phases present in the glass. Thus, for example, the total amount of SiO₂ in a phase separated glass comprising two phases refers to the combined amount of SiO₂ that may be present in both phases.

Phase separated glasses of the present disclosure may comprise a total amount of Al₂O₃ in a range from about 3 mol % to about 13 mol %, for example in a range from about 3 mol % to about 12 mol %, in a range from about 3 mol % to about 11 mol %, in a range from about 3 mol % to about 10 mol %, in a range from about 3 mol % to about 9 mol %, in a range from about 3 mol % to about 8 mol %, in a range from about 3 mol % to about 7 mol %, in a range from about 3 mol % to about 6 mol %, in a range from about 3 mol % to about 5 mol %, in a range from about 3 mol % to about 4 mol %, in a range from about 4 mol % to about 13 mol %, in a range from about 5 mol % to about 13 mol %, in a range from about 6 mol % to about 13 mol %, in a range from about 7 mol % to about 13 mol %, in a range from about 8 mol % to about 13 mol %, in a range from about 8 mol % to about 13 mol %, in a range from about 9 mol % to about 13 mol %, in a range from about 10 mol % to about 13 mol %, in a range from about 11 mol % to about 13 mole %, or in a range from about 12 mol % to about 13 mol %, including all ranges and subranges therebetween. In some embodiments, glass of the present disclosure may comprise a total amount of Al₂O₃ in a range from about 7.6 mol % to about 8.7 mol %, for example in a range from about 7.6 mol % to about 8.6 mol %, in a range from about 7.6 mol % to about 8.5 mol %, in a range from about 7.6 mol % to about 8.4 mol %, in a range from about 7.6 mol % to about 8.3 mol %, in a range from about 7.6 mol % to about 8.2 mol %, in a range from about 7.6 mol % to about 8.1 mol %, in a range from about 7.6 mol % to about 8.0 mol %, in a range from about 7.6 mol % to about 7.9 mol %, in a range from about 7.6 mol % to about 7.8 mol %, in a range from about 7.6 mol % to about 7.7 mol %, in a range from about 7.7 mol % to about 8.7 mol %, in a range from about 7.8 mol % to about 8.7 mol %, in a range from about 7.8 mol % to about 8.7 mol %, in a range from about 7.9 mol % to about 8.7 mol %, in a range from about 8.0 mol % to about 8.7 mol %, in a range from about 8.1 mol % to about 8.7 mol %, in a range from about 8.2 mol % to about 8.7 mol %, in a range from about 8.3 mol % to about 8.7 mol %, in a rage from about 8.4 mol % to about 8.7 mol %, in a range from about 8.5 mol % to about 8.7 mol %, or in a range from about 8.6 mol % to about 8.7 mol %, including all ranges and subranges therebetween.

Phase separated glasses of the present disclosure may comprise a total amount of B₂O₃ in a range from about 9% to about 20%, for example in a range from about 10 mol % to about 20 mol %, in a range from about 11 mol % to about 20 mole %, in a range from about 12 mol % to about 20 mol %, in a range from about 13 mol % to about 20 mol %, in a range from about 14 mol % to about 20 mol %, in a range from about 15 mol % to about 20 mol %, in a range from about 16 mol % to about 20 mole %, in a range from about 17 mol % to about 20 mol %, in a range from about 28 mol % to about 20 mol %, in arrange from about 19 mol % to about 20 mol %, in a range from about 19% to about 9%, for example in a range from about 18 mol % to about 9 mol %, in a range from about 17 mol % to about 9 mole %, in a range from about 16 mol % to about 9 mol %, in a range from about 15 mol % to about 9 mol %, in a range from about 14 mol % to about 9 mol %, in a range from about 13 mol % to about 9 mol %, in a range from about 12 mol % to about 9 mole %, in a range from about 11 mol % to about 9 mol %, or in a range from about 10 mol % to about 9 mol %, including all ranges and subranges therebetween. In some embodiments, glasses of the present disclosure may comprise a total amount of B₂O₃ in a range from about 11.9 mol % to about 14.1 mol %, for example in a range from about 11.9 mol % to about 13.8 mol %, in a range from about 11.9 mol % to about 13.6 mol %, in a range from about 11.9 mol % to about 13.4 mol %, in a range from about 11.9 mol % to about 13.2 mol %, in a range from about 11.9 mol % to about 13.0 mol %, in a range from about 11.9 mol % to about 12.8 mol %, in a range from about 11.9 mol % to about 12.6 mol %, in a range from about 11.9 mol % to about 12.4 mol %, in a range from about 11.9 mol % to about 12.2 mol %, in a range from about 12.0 mol % to about 14.1 mol %, in a range from about 12.2 mol % to about 14.1 mol %, in a range from about 12.3 mol % to about 14.1 mol %, in a range from about 12.4 mol % to about 14.1 mol %, in a range from about 12.5 mol % to about 14.1 mol %, in a range from about 12.6 mol % to about 14.1 mol %, in a range from about 12.8 mol % to about 14.1 mol %, in a range from about 13.0 mol % to about 14.1 mol %, in a range from about 13.2 mol % to about 14.1 mol %, in a range from about 13.4 mol % to about 14.1 mol %, in a range from about 13.6 mol % to about 14.1 mol %, in a range from about 13.8 mol % to about 14.1 mol %, including all ranges and subranges therebetween.

Increasing amounts of SiO₂ can decrease the dielectric constant and loss tangent of the glass at frequencies of 10 GHz or greater; however, increasing amounts of SiO₂ may decrease formability of the glass, and in particular formability by down-draw processes. For example, as the amount of SiO₂ increases, the liquidus temperature of the glass may increase. Pure SiO₂ has a low CTE, and, due to its high melting temperature, is incompatible with down-draw processes. B₂O₃ can be added to lower the viscosity of the glass and reduce the liquidus temperature to facilitate forming of the glass, particularly by down-draw processes. B₂O₃ can have the effect of decreasing the liquidus temperature more rapidly than the viscosity, and thus may improve the liquidus viscosity for forming by down-draw processes. Al₂O₃ can reduce the liquidus temperature and thus increase the liquidus viscosity. Thus, the amounts of SiO₂, B₂O₃, and optionally Al₂O₃, can be selected according to the present disclosure to balance the desired dielectric properties and formability of the glass.

In some aspects of the present disclosure, the total amounts of SiO₂, B₂O₃, and Al₂O₃ in the glass may be selected such that a ratio of B₂O₃:(Al₂O₃+SiO₂) is from about 0.1 to about 0.3, for example in a range from about 0.12 to about 0.3, in a range from about 0.14 to about 0.3, in a range from about 0.16 to about 0.3, in a ranger from about 0.18 to about 0.3, in a range from about 0.2 to about 0.3, in a range from about 0.22 to about 0.3, in a range from about 0.24 to about 0.3, in a range from about 0.26 to about 0.3, or in a range from about 0.28 to about 0.3, including all arranges and subranges therebetween. In some aspects, the ratio of B₂O₃:(Al₂O₃+SiO₂) may be from about 0.16 to about 0.18, about 0.16 to about 0.17, or in a range from about 0.17 to about 0.18.

In some aspects, the total amounts of SiO₂ and B₂O₃ may be selected such that a sum of SiO₂ plus B₂O₃ is from about 77 mol % to about 84 mol %, for example in a range from about 78 mol % to about 84 mol %, in a range from about 79 mol % to about 84 mol %, in a range from about 80 mol % to about 84 mol %, in a range from about 81 mol % to about 84 mol %, in a range from about 82 to about 84 mol %, in a range from about 83 mol % to about 84 mol %, in a range from about 77 mol % to about 83 mol %, in a range from about 77 mol % to about 82 mol %, in a range from about 77 mol % to about 81 mol %, in a range from about 77 mol % to about 80 mol %, in a range from about 77 mol % to about 79 mol %, or in a range from about 77 mol % to about 78 mol %, including all ranges and subranges therebetween.

In some aspects, the total amounts of SiO₂, B₂O₃, and Al₂O₃ in phase separated glasses disclosed herein may be selected such that a sum of SiO₂ plus B₂O₃ plus Al₂O₃ is from about 85 mol % to about 93 mol %, for example in a range from about 86 mol % to about 93 mol %, in a range from about 87 mol % to about 93 mol %, in a range from about 88 mol % to about 93 mol %, in a range from about 89 mol % to about 93 mol %, in a range from about 90 mol % to about 93 mol %, in a range from about 91 mol % to about 93 mol %, in a range from about 92 mol % to about 93 mol %, in a range from about 85 mol % to about 92 mol %, in a range from about 85 mol % to about 91 mol %, in a range from about 85 mol % to about 90 mol %, in a range from about 85 mol % to about 89 mol %, in a range from about 85 mol % to about 88 mol %, in a range from about 85 mol % to about 88 mol %, in a range from about 85 mol % to about 87 mol %, or in a range from about 85 mol % to about 86 mol %, including all ranges and subranges therebetween.

According to some aspects, when present, the phase separated glass can include one or more alkaline earth oxides (RO), where RO is MgO, CaO, BaO, and/or SrO.

Phase separated glasses of the present disclosure may comprise a total amount of MgO in a range from about 4% to about 6%, for example in a range from about 4 mol % to about 5.8 mol %, in a range from about 4 mol % to about 5.6 mole %, in a range from about 4 mol % to about 5.4 mol %, in a range from about 4 mol % to about 5.2 mol %, in a range from about 4 mol % to about 5 mol %, in a range from about 4 mol % to about 4.8 mol %, in a range from about 4 mol % to about 4.6 mole %, in a range from about 4 mol % to about 4.4 mol %, in a range from about 4 mol % to about 4.2 mol %, in a range from about 4.2 mol % to about 6 mol %, in a range from about 4.4 mol % to about 6%, for example in a range from about 4.6 mol % to about 6 mol %, in a range from about 4.8 mol % to about 6 mole %, in a range from about 5 mol % to about 6 mol %, in a range from about 5.2 mol % to about 6 mol %, in a range from about 5.4 mol % to about 6 mol %, in a range from about 5.6 mol % to about 6 mol %, or in a range from about 5.8 mol % to about 6 mole %, including all ranges and subranges therebetween.

Phase separated glasses of the present disclosure may comprise a total amount of CaO in a range from about 3 mol % to about 6 mol %, for example in a range from about 3.2 mol % to about 6 mol %, in a range from about 3.4 mol % to about 6 mole %, in a range from about 3.6 mol % to about 6 mol %, in a range from about 3.8 mol % to about 6 mol %, in a range from about 4 mol % to about 6 mol %, in a range from about 4.2 mol % to about 6 mol %, in a range from about 4.4 mol % to about 6 mole %, in a range from about 4.6 mol % to about 6 mol %, in a range from about 4.8 mol % to about 6 mol %, in a range from about 5 mol % to about 6 mol %, in a range from about 5.2 mol % to about 6%, for example in a range from about 5.4 mol % to about 6 mol %, in a range from about 5.6 mol % to about 6 mole %, in a range from about 5.8 mol % to about 6 mol %, in a range from about 3 mol % to about 5.8 mol %, in a range from about 3 mol % to about 5.6 mol %, in a range from about 3 mol % to about 5.4 mol %, in a range from about 3 mol % to about 5.2 mol %, in a range from about 3 mol % to about 5 mol %, in a range from about 3 mol % to about 4.8 mol %, in a range from about 3 mol % to about 4.6 mol %, in a range from about 3 mol % to about 4.4 mol %, in a range from about 3 mol % to about 4.4 mol %, in a range from about 3 mol % to about 4.2 mol %, in a range from about 3 mol % to about 4 mol %, in a range from about 3 mol % to about 3.8 mol %, in a range from about 3 mol % to about 3.6 mol %, in a range from about 3 mol % to about 3.4 mol %, or in a range from about 3 mol % to about 3.2 mole %, including all ranges and subranges therebetween.

Phase separated glasses of the present disclosure may comprise a total amount of SrO less than about 0.2 mol %, for example in a range from about 0% to about 0.2 mol %, for example in a range from about 0.02 mol % to about 0.2 mol %, in a range from about 0.04 mol % to about 0.2 mol %, in a range from about 0.06 mol % to about 0.2 mol %, in a range from about 0.08 mol % to about 0.2 mol %, in a range from about 0.1 mol % to about 0.2 mol %, in a range from about 0.12 mol % to about 0.2 mol %, in a range from about 0.14 mol % to about 0.2 mol %, in a range from about 0.16 mol % to about 0.2 mol %, in a range from about 0.18 mol % to about 0.2 mol %, in a range from about 0 mol % to about 0.18 mol %, in a range from about 0 mol % to about 0.16 mol %, in a range from about 0 mol % to about 0.14 mol %, in a range from about 0 mol % to about 0.12 mol %, in a range from about 0 mol % to about 0.1 mol %, in a range from about 0 mol % to about 0.08 mol %, in a range from about 0 mol % to about 0.06 mol %, in a range from about 0 mol % to about 0.4 mol %, or in a range from about 0 mol % to about 0.02 mol %, including all ranges and subranges therebetween.

Phase separated glasses of the present disclosure may optionally comprise a total amount of BaO less than about 1 mol %, for example in a range from about 0% to about 1 mol %, such as in a range from about 0.1 mol % to about 1 mol %, in a range from about 0.2 mol % to about 1 mol %, in a range from about 0.3 mol % to about 1 mol %, in a range from about 0.4 mol % to about 1 mol %, in a range from about 0.5 mol % to about 1 mol %, in a range from about 0.6 mol % to about 1 mol %, in a range from about 0.7 mol % to about 1 mol %, in a range from about 0.8 mol % to about 1 mol %, in a range from about 0.9 mol % to about 1 mol %, in a range from about 0 mol % to about 0.9 mol %, in a range from about 0 mol % to about 0.8 mol %, in a range from about 0 mol % to about 0.7 mol %, in a range from about 0 mol % to about 0.6 mol %, in a range from about 0 mol % to about 0.5 mol %, in a range from about 0 mol % to about 0.4 mol %, in a range from about 0 mol % to about 0.3 mol %, in a range from about 0 mol % to about 0.2 mol %, or in a range from about 0 mol % to about 0.1 mol %, including all ranges and subranges therebetween.

In some aspects, the one or more alkaline earth oxides may be present in a combined amount of from about 4.6 mol % to about 14.2 mol %, for example in a range from about 4.8 mol % to about 14.2 mol %, in a range from about 5 mol % to about 14.2 mol %, in a range from about 5.4 mol % to about 14.2 mol %, in a range from about 5.8 mol % to about 14.2 mol %, in a range from about 6.2 mol % to about 14.2 mol %, in a range from about 7.2 mol % to about 14.2 mol %, in a range from about 8.2 mol % to about 14.2 mol %, in a range from about 9.2 mol % to about 14.2 mol %, in a range from about 10.2 mol % to about 14.2 mol %, in a range from about 11.2 mol % to about 14.2 mol %, in a range from about 12.2 mol % to about 14.2 mol %, in a range from about 13.2 mol % to about 14.2 mol %, in a range from about 4.6 mol % to about 13.6 mol %, in a range from about 4.6 mol % to about 12.6 mol %, in a range from about 4.6 mol % to about 11.6 mol %, in a range from about 4.6 mol % to about 10.6 mol %, in a range from about 4.6 mol % to about 9.6 mol %, in a range from about 4.6 mol % to about 8.6 mol %, in a range from about 4.6 mol % to about 7.6 mol %, in a range from about 4.6 mol % to about 6.6 mol %, or in a range from about 4.6 mol % to about 5.6 mol %, including all ranges and subranges therebetween.

According to some aspects of the present disclosure, the phase separated glass can include MgO and at least one additional alkaline earth oxide (RO), selected from CaO, BaO, and SrO. In some examples, the combination of MgO and at least one additional RO can result in a glass having a lower dielectric constant and/or loss tangent compared to a glass that includes MgO or another RO alone.

In some aspects, the total amount of MgO and the total amount of additional RO are selected as described above and in concert with the total amount of Al₂O₃ present in the glass such that a ratio of RO_{Total} to Al₂O₃(RO_{Total}:Al₂O₃) is greater than 1. Providing a glass with a ratio RO_{Total}:Al₂O₃ greater than 1, can facilitate forming a manufacturable glass that can be drawn using conventional glass forming processes.

In some aspects, a ratio of the total amount of MgO to RO_{Total} (MgO:RO_{Total}) may be in a range from about 0.3 to about 4.7, for example in a range from about 0.3 to about 4.5, in a range from about 0.3 to about 0.4, in a range from about 0.3 to about 3.5, in a range from about 0.3 to about 3, in a range from about 0.3 to about 2.5, in a range from about 0.3 to about 2, in a range from about 0.5 to about 1.5, in a range from about 0.5 to about 4.7, in a range from about 1 to about 4.7, in a range from about 1.5 to about 4.7, in a range from about 2 to about 4.7, in a range from about 2.5 to about 4.7, in a range from about 3 to about 4.7, in a range from about 3.5 to about 4.7, or in a range from about 4 to about 4.7, including all ranges and subranges therebetween.

For a given phase separated glass, a lower dielectric constant and/or loss tangent may be achieved in the glass sample by decreasing the concentration of the single RO species present in the glass. Further, it is believed that for a given RO_{Total} concentration, a reduced dielectric constant and/or loss tangent may be achieved in the glass sample by combining MgO with at least one additional RO species, such as CaO, SrO, and/or BaO, compared to a glass derived from a precursor composition having a similar RO_{Total} concentration, but which includes only a single RO species. For example, for a given RO_{Total} concentration, a glass including a combination of MgO plus CaO, SrO, and/or BaO according to the present disclosure may have a lower dielectric constant than a glass that includes only a single RO species selected from MgO, CaO, SrO, or BaO. In another example, for a given RO_{Total} concentration, a glass including a combination of MgO plus CaO, SrO, and/or BaO according to the present disclosure may have a lower loss tangent than a glass that includes only a single RO species selected from CaO, SrO, or BaO.

Without wishing to be bound by theory, it is believed that for a glass derived from a precursor composition having a single RO species, as the concentration of the single RO species decreases, the dielectric constant and the loss tangent of the derived glass, as measured with signals of 10 GHz, also decreases.

In some aspects, the amount of alkaline earth oxides in the phase separated glass can be selected in combination with other materials, such as B₂O₃ and optionally Al₂O₃, to provide phase separated glasses having desired characteristics. For example, increasing the amount of alkaline earth oxides relative to SiO₂ and Al₂O₃ can have the effect of decreasing the viscosity of a glass melt and may increase melting and forming temperatures. Alkaline earth oxides may also increase the CTE and density of the glass, and may affect other properties as well, such as the elastic modulus. Alkaline earth oxides can also decrease the liquidus temperature. Thus, in some aspects, the total amounts of the alkaline earth oxides, B₂O₃, and Al₂O₃ can be selected according to the present disclosure to balance the desired physical properties and formability of the glass.

Phase separated glasses of the present disclosure may optionally comprise a total amount of ZnO less than about 2 mol %, for example in a range from about 0 mol % to about 1.5 mol %, in a range from about 0 mol % to about 1 mol %, in a range from about 0 mol % to about 0.5 mol %, in range from about 0.5 mol % to about 2 mol %, in a range from about 1 mol % to about 2 mol %, or in a range from about 1.5 mol % to about 2 mol %, including all ranges and subranges therebetween.

In some aspects, the total amounts of alkaline earth oxides, B₂O₃, and Al₂O₃ may be selected such that a ratio of RO_{Total}:(Al₂O₃+B₂O₃) in the glass is from about 0.2 to about 0.6. In some aspects, the ratio of RO_{Total}:(Al₂O₃+B₂O₃) is from about 0.2 to about 0.6, about 0.2 to about 0.5, about 0.2 to about 0.4, about 0.3 to about 0.6, about 0.3 to about 0.5, about 0.3 to about 0.4, about 0.4 to about 0.6, about 0.4 to about 0.5, or about 0.5 to about 0.6. In some aspects, the ratio of RO_{Total}:(Al₂O₃+B₂O₃) is about 0.2, about 0.24, about 0.25, about 0.28, about 0.29, about 0.3, about 0.32, about 0.35, about 0.36, about 0.4, about 0.5, about 0.55, about 0.58, about 0.6, or any ratio between these values.

Phase separated glasses of the present disclosure may optionally include one or more fining agents, such as, by way of non-limiting example, SnO₂, Sb₂O₃, As₂O₃, and/or one or more halogen salts, including fluorine, chlorine, or bromine salts. When one or more fining agents are present in the glass, the fining agents may be present in a total amount less than about 1 mol %. In some aspects, the fining agents may be present in an amount of about 0.01 mol % to about 1 mol %, for example in an amount in a range from about 0.01 mol % to about 1 mol %, in a range from about 0.01 mol % to about 0.09 mol %, in a range from about 0.01 mol % to about 0.08 mol %, in a range from about 0.01 mol % to about 0.07 mol %, in a range from about 0.01 mol % to about 0.06 mol %, in a range from ab out 0.01 mol % to about 0.05 mol %, in a range from about 0.01 mol % to about 0.04 mol %, in a range from about 0.01 mol % to about 0.03 mol %, in a range from about 0.01 mol % to about 0.02 mol %, in a range from about 0.02 mol % to about 0.1 mol %, in a range from about 0.02 mol % to about 0.01 mol %, in a range from about 0.03 mol % to about 0.1 mol %, in a range from about 0.04 mol % to about 0.1 mol %, in a range from about 0.05 mol % to about 0.1 mol %, in a range from about 0.06 mol % to about 0.1 mol %, in a range from about 0.07 mol % to about 0.1 mol %, in a range from about 0.08 mol % to about 0.1 mol %, in a range from about 0.08 mol % to about 0.1 mol %, or in a range from about 0.09 mol % to about 0.1 mol %. However, in other embodiments, the fining agents may be present in an amount in a range from about 0.01 mol % to about 0.5 mol %.

When the content of the fining agents in the phase separated glass is too large, the fining agents may enter the glass structure and affect various glass properties. However, when the content of the fining agents is too low, the phase separated glass may be difficult to form. According to one aspect of the disclosure, SnO₂ may be included as a fining agent in a total amount in a range from about 0 mol % to about 0.3 mol %. For example, SnO₂ may be present in a total amount in a range from about 0 mol % to about 0.3 mol %, in a range from about 0 mol % to about 0.2 mol %, in a range from about 0 mol % to about 0.1 mol %, in a range from about 0.05 mol % to about 0.3 mol %, in a range from about 0.05 mol % to about 0.2 mol %, or in a range from about 0.05 mol % to about 0.1 mol %.

The phase separated glass may optionally include contaminants or unintended additives, such as TiO₂ or ZrO₂. These additional materials, when present, are typically present in very low or trace total amounts of less than about 0.5 mol %, for example in a range from 0 to about 0.4 mol %, in a range from 0 to about 0.4 mol %, in a range from 0 to about 0.3 mol %, in a range from 0 to about 0.3 mol %, in a range from 0 to about 0.2 mol %, or in a range from 0 to about 0.1 mol %.

In some aspects, phase separated glasses of the present disclosure may be substantially free of alkali metal. As used herein, the phrase “substantially free” is defined to mean no more than trace amounts of the material, in this case, alkali metal oxides, are present, for example a total amount no more than about 0.5 mole %, no more than 0.4 mol %, no more than 0.3 mol %, no more than about 0.2 mol %, or no more than about 0.1 mol %. Trace amounts of alkali metal oxides may be present due to contamination or limitations in manufacturing. As discussed above, in some implementations, glasses of the present disclosure can be prepared without the addition of alkali metals such that the glasses are substantially free of alkali metals to decrease the likelihood of ion migration during thermal treatment of articles formed from the glass. Decreasing or minimizing the likelihood of ion migration may be advantageous in some applications, such when the glasses are used as a substrate in an electronic device where ion migration may be undesirable.

In some aspects, phase separated glasses of the present disclosure can include at least one alkali metal oxide (R₂O), where R₂O is Li₂O, Na₂O, and/or K₂O. In some aspects, the one or more alkali metal oxides may be present individually or in a combined amount of from 0 mol % to about 1 mol %. In some aspects, the one or more alkali metal oxides may be present individually or in a combined amount of from 0 mol % to about 1 mol %, 0 mol % to about 0.9 mol %, 0 mol % to about 0.8 mol %, 0 mol % to about 0.7 mol %, 0 mol % to about 0.6 mol %. For example, Na₂O may be present in a total amount of from 0 mol % to about 0.05 mol %, 0 mol % to about 0.01 mol %, 0 mol % to about 0.005 mol %, 0 mol % to about 0.001 mol %, about 0.001 mol % to about 0.05 mol %, about 0.001 mol % to about 0.01 mol %, or about 0.001 mol % to about 0.005 mol %. In another example, K₂O can be present in a total amount of from 0 mol % to about 2 mol %, 0 mol % to about 1 mol %, 0 mol % to about 0.5 mol %, about 0.1 mol % to about 2 mol %, about 0.1 mol % to about 1 mol %, about 0.1 mol % to about 0.5 mol %, about 0.5 mol % to about 2 mol %, or about 0.5 mol % to about 1 mol %.

In some aspects, phase separated glasses of the present disclosure can be characterized by a dielectric constant Dₖ of about 10 or less, as measured with signals at 10 GHz. In some implementations, the phase separated glass may have a dielectric constant Dₖ of about 6 or less, such as about 5 or less, as measured with signals at 10 GHz. In some implementations, the phase separated glass may have a dielectric constant Dₖ of about 4.5 to about 6, as measured with signals at 10 GHz.

In some aspects, phase separated glasses of the present disclosure can be characterized by a loss tangent D_{f} of about 0.004 or less, as measured with signals at 10 GHz. For example, phase separated glasses of the present disclosure can be characterized by a loss tangent of about 0.003 or less, as measured with signals at 10 GHz. In some aspects, phase separated glasses of the present disclosure can be characterized by a loss tangent of about 0.0029 to about 0.004, as measured with signals at 10 GHz. Unless otherwise specified, dielectric properties Dₖ and D_{f} were measured on polished, as-made glass samples that were 3″×3″ and less than 1 mm thick. Test frequencies ranged from 2.7 GHz to 50 GHz. The samples were tested with a split post dielectric resonator at signal frequencies equal to or less than 10 GHz or an open cavity resonator at signal frequencies greater than 10 GHz. In each case, the dielectric constant and loss tangent were measured from the shift and the broadening of the resonance peaks.

Phase separated glasses of the present disclosure may be suitable for use in PCB applications. A PCB laminate typically includes an insulating layer laminated to copper films, for example with the insulating layer disposed between copper clad films. The insulating layer preferably has a low dielectric loss, for example less than 0.005 at 10 GHz, and sufficient mechanical strength and fracture toughness to allow for handling and post processing in a production environment. The insulating layer should also be able withstand hole drilling without damage or fracture and, depending on the application, can be in a range of about 100 to 700 micrometers thick. In addition, the insulating layer may withstand temperatures of up to 260° C. for 30 seconds while maintaining dimensional stability. This temperature is usually based on the temperature required for solder reflow in post processing of the PCB boards.

Solder paste is generally used to attach the electrical components to their conductive contact pads. The assembly is then exposed to high temperatures (usually 260° C. for 30 seconds) to cause the solder to reflow and create a permanent solder joint. Thus, the insulating layer of the PCB should preferably be a low dielectric loss material that can also withstand soldering reflow temperatures typically used in PCB processing with little to no softening or dimensional change.

It has been observed that during a drawing process, wherein a phase separated glass is placed under tension, for example in a downdraw process, and drawn, for example, into a glass sheet, optical retardation may be produced in the phase separated glass sheet as evidenced by stress across the glass sheet as shown by strain scope measurements using polarized light. Annealing has been shown to increase optical retardation. The longer the anneal time, the greater the optical retardation may be.

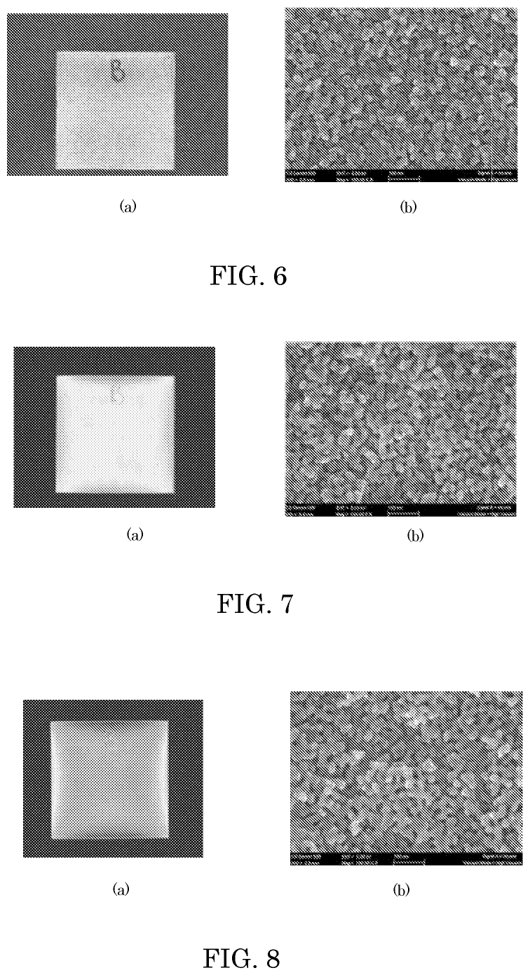

FIGS. 5, 6, and 7 illustrate (1) strain scope images of an approximately 3-centimeter (cm)×3 cm sample of a phase separated glass sheet (5(a), 6(a), and 7(a)) and (2) photographs (FIGS. 5(b), 6(b), and 7(b)) from a scanning electron microscope (SEM) showing the phases of the glass samples. The sample of FIG. 5 is an as-drawn sample of the glass, without subsequent annealing. The sample of FIG. 6 is the sample after annealing for 2 hours at 720° C. FIG. 7 depicts the sample of FIG. 6 after annealing for a second time, for an additional 2 hours at 720° C. (i.e., four hours total). The increased shading, via strain scope measurement, particularly of the sample of FIG. 7(a), is indicative of increased optical retardation. Moreover, an increase in size of the secondary phase as the samples were annealed is clearly evident when comparing the SEM images of FIGS. 5-7.

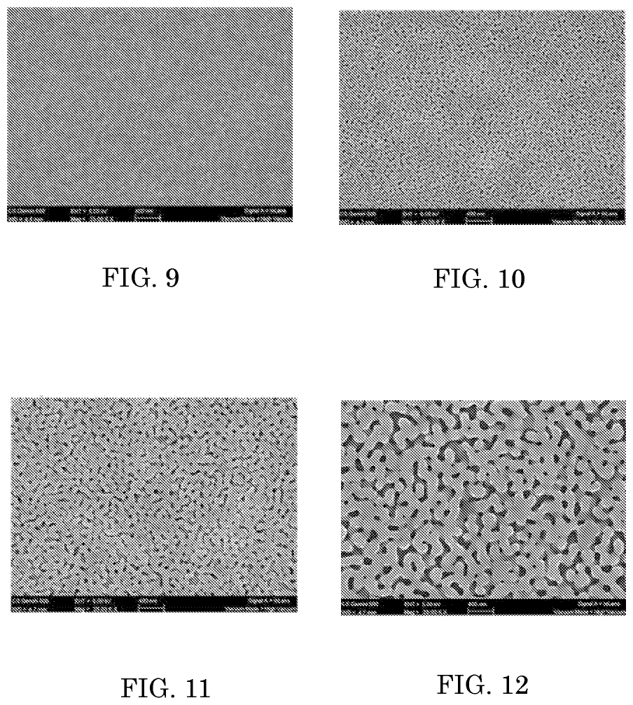

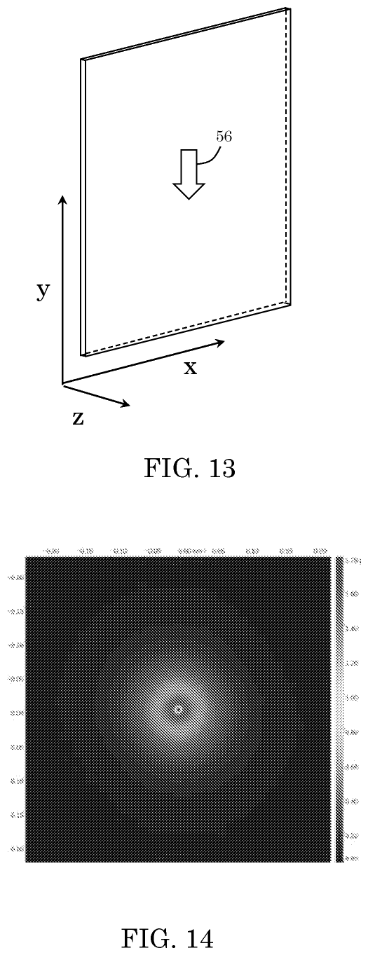

FIGS. 8-11 illustrate SEM photographs of samples of the phase separated glass composition of FIG. 5 after annealing at increasingly greater temperature. For example, the sample of FIG. 8 was annealed at a temperature of about 745° C. for a period of about 12 hours. The features indicating phase separation were quite fine and visually difficult to discern. The sample of FIG. 9 was annealed at a temperature of about 800° C. for approximately 12 hours. Here, the two phases of the glass become visually distinct, although still small. The sample of FIG. 10 was annealed at a temperature of approximately 850° C. for a period of about 12 hours.

Distinct phases are clearly visible. The sample of FIG. 11 was annealed at a temperature of about 900° C. for a period of about 12 hours. As is clearly evident, the separate phases of the glass are easily distinguished. Similar to the results of FIGS. 5,6,7, the greater the anneal temperature, the greater the extent of phase separation, as evidence by the growth of the secondary phase. Whereas the secondary phase in FIG. 8 is barely discernable, the secondary phase is clearly visible in the image of FIG. 11.

Images similar to those of FIGS. 8-11 were analyzed using two-dimensional Fourier transform techniques. The samples were etched with a series of different etch times in an attempt to accentuate the spatial distribution of the two phases. Close examination of the images revealed the edges of the more-slowly-etched material phase were brighter than the faster-etching phase, giving a signal from the SEM image that was associated with the spatial orientation of the phases. The two-dimensional Fourier transform can be described mathematically using the following equation:

$$F ( u , v ) = {{\int \int }^{∞}}_{- ∞} f ( x , y ) exp [ 2 π i ( ux + vy ) ] dxdy$$

where x and y are the coordinates of the physical structure, f(x,y) is the signal from the physical structure to be analyzed (in this instance, the intensity of the backscatter SEM image), u and v are the coordinates in the Fourier domain, and F(u,v) is the Fourier transform of the function f(x,y).

To understand how the Fourier transform helps identify the spatial orientation of the phases, a few illustrative examples are inspected. First, consider the case in which the phases are oriented into alternating vertical lines. The two-dimensional Fourier transform would consist of a series of peaks in the horizontal direction of the Fourier plane. The spacing between the peaks would provide information about the width of the vertical regions of the phases. The width of the peaks would provide information about the variation in the width of the vertical regions. A similar response is expected if the phases are oriented in alternating horizontal lines, except the peaks in the Fourier transform would be in the vertical direction, rather than the horizontal direction. In both cases, the amplitude of the peaks in the Fourier domain would provide information about how many of the domains have a particular orientation.

If the material phases are randomly oriented vertically, horizontally, and at every azimuthal angle in the physical plane, but with nearly constant width, the Fourier transform would consist of an annulus, where the peak position in the Fourier domain would be inversely proportional to the phase domain widths. The width of the peak would provide information about the distribution of the phase domain widths.

The SEM images can be described using a coordinate system illustrated in FIG. 12. The draw direction (represented by arrow 56 in the figure) extends along the y axis (in the −y direction), the thickness of the glass sheet is in the z direction, and the x direction is orthogonal to each of the draw and thickness directions. A sample is referred to as a x cross-sectional image if the surface normal of the surface from which the sample was taken is parallel to the x direction.

The two-dimensional Fourier transform (2DFT) corresponding to a sample measured from an x surface is shown in FIG. 14. The pale halo around the central dot is the annular ring corresponding to the characteristic width of the phase separation features (i.e., the secondary phase) shown in FIG. 11. Its uniformity in radius and width indicates the structure is nearly isotropic for this 2D cross section. However, it is somewhat easier to see nonuniformity if we plot the figure in a rθ space, rather than an uv space, where

$$r = \sqrt{{u}^{2} + {v}^{2}}$$

and θ=tan⁻¹[y/x].

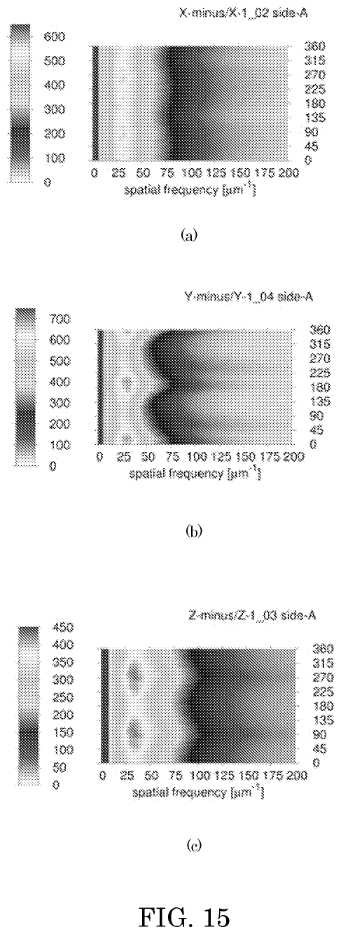

The data for samples from the three surfaces plotted in this rd coordinate system are shown in greyscale in FIG. 15(a)-(c). The vertical axis is the azimuthal direction, θ. The horizontal dimension is the radial direction in the xy Fourier plane, r. The results show the structure of the two phases is isotropic in the azimuthal direction (vertical axes), but the spatial frequency of 31 μm⁻¹, indicates the width of the phases is nearly uniform, with a width of approximately 32 nm. While the 2DFT cross-section from the x sample shows very little anisotropy, the samples in the y and z surfaces, (whose surface normals are along the draw direction and along the thickness direction, respectively) show a larger azimuthal variation, as well as a wider variation in the width of the peaks, indicating the material phase regions are being compressed (higher spatial frequency indicates smaller domain widths). These results indicate the anisotropy of the spatial distribution of the material phases of the phase-separated material can vary more strongly, depending on the orientation of the material with respect to the draw and thickness directions, than directions perpendicular to those directions—that is, within the glass sheet, but perpendicular to the draw direction.

Unlike other glasses that may be treated post-forming to induce phase separation, such as by heat treating the glass, it is believed phase separated glasses of the present disclosure phase separate by spontaneous spinodal decomposition while the molten glass flows through downstream glass manufacturing apparatus 30, for example as the molten glass traverses the various connecting conduits and vessels downstream of the melting vessel and before the forming body. This belief is supported by the effect the drawing of the molten glass from the forming body has on the orientation of the phases. To wit, the phase separation must have already occurred for the draw tension to affect the phase orientation.

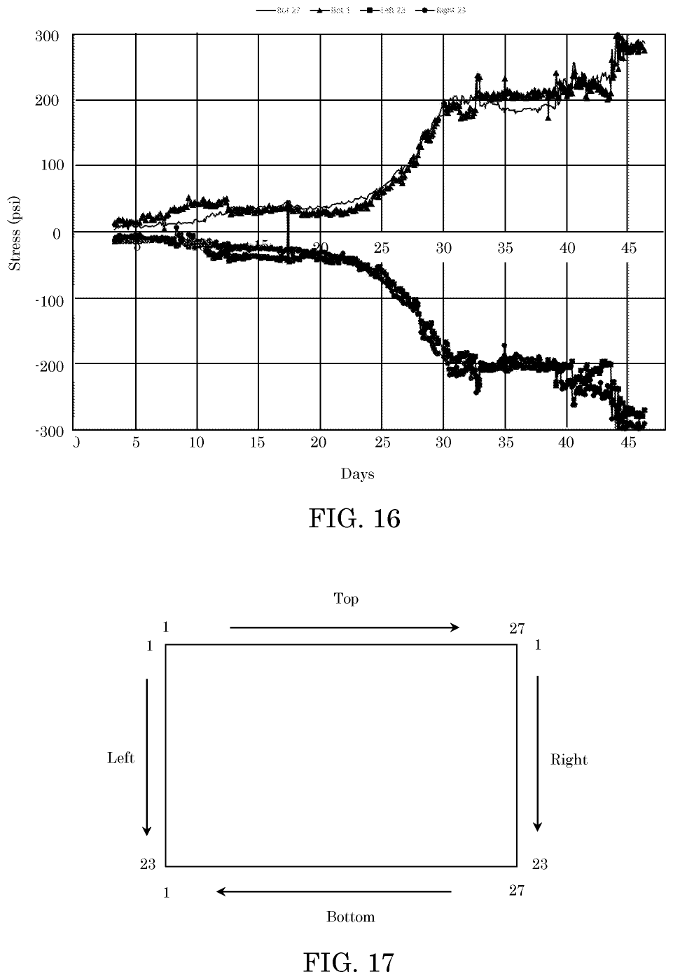

FIG. 16 illustrates stress in glass ribbon drawn in a fusion downdraw process as the glass composition was changed from a commercially available non-phase separated glass (i.e., Corning® Eagle™ XG®) to a phase separated glass composition as a function of time. The transition occurred over a period of approximately one month. The transition was accomplished by slowly varying the glass composition while striving to maintain a stable glass density. Stress data was collected at the edges of the glass sheet (e.g., corners and sides—see FIG. 17). The data show a gradual change in stress (pounds per square inch, psi) from virtually no difference in stress at the beginning of the transition (e.g., about day 3, which would be expected from the commercially available glass), to a stress in excess of +/−250 pounds per square inch (psi) at the completion of the transition, and as much as +/−300 psi by day 45.

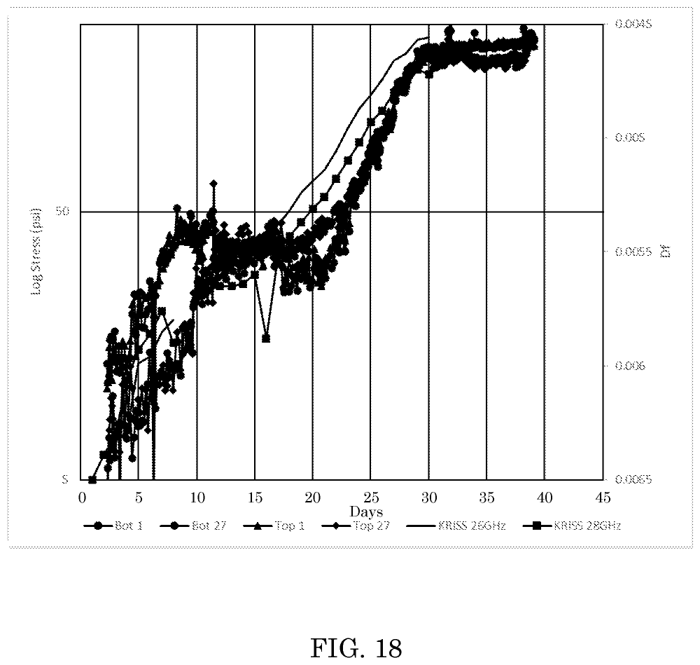

FIG. 18 is a graph showing loss tangent D_{f} plotted with the log₁₀ of stress (in psi) as a function of time during the transition from the Corning® Eagle™ XG® glass to the phase separated glass at various locations on the glass sheet (refer to FIG. 16). The data show both an increase in stress responsible for inherent birefringence and a decrease in loss tangent (e.g., from about 0.0065 to about 0.0045).

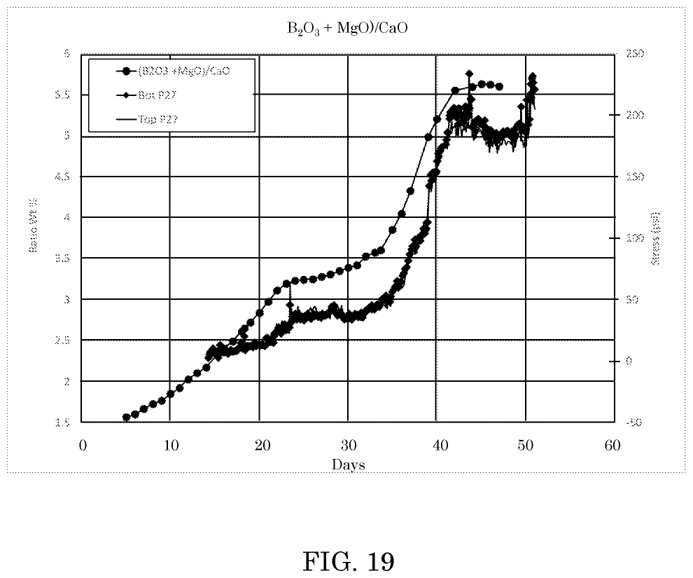

FIG. 19 is a plot of the ratio (B₂O₃+MgO)/CaO (when the individual constituents are expressed in mole %) coplotted with stress (in psi), at several locations on the sheet (refer to FIG. 16) during the transition, showing the dielectric property was changing with compositional change.

The primary glass phase of phase separated glasses disclosed herein is rich in SiO₂, whereas the secondary phase is rich in boron (e.g., B₂O₃). As described above, the greater the amount of SiO₂ in phase separated glass, the more favorable the dielectric properties as components for electronic circuits (e.g., dielectric constant, Dₖ, and loss tangent, D_{f}). That is, the dielectric constant and/or loss tangent may be decreased by increasing the amount of SiO₂.

However, increasing the amount of SiO₂ in the glass makes the glass less formable by conventional sheet-forming means, e.g., fusion downdraw processes. On the other hand, because the principal form of such electronic (e.g., dielectric) components in PCBs is as thin sheets, high volume production methods may offer beneficially reduced costs. Accordingly, methods of modifying the composition of phase separated intermediate sheets of glass are described, wherein the amount of SiO₂ in a phase of the glass may be greatly increased after forming the glass sheet. Thus, high-volume production methods may be utilized to form an intermediate glass sheet, whereupon the intermediate glass sheet is further processed to produce a glass article an SiO₂-rich phase.

In accordance with the present disclosure, a phase separated glass article can be etched with a suitable etchant to remove substantially all of the boron-rich secondary phase while leaving a silica-rich porous glass article including the silica-rich primary phase. In some embodiments, the porous glass article may subsequently be heated to consolidate the porous glass article into a silica-rich solid glass article, e.g., glass sheet.

Accordingly, a method is described comprising a first step of forming a glass sheet comprising a phase separated glass including at least a first phase and a second phase, such as a phase separated glass as described herein. The phase separated glass sheet may comprise a width greater than about 340 mm and a length greater than about 440 mm, a width greater than about 680 mm and a length greater than about 880 mm, or a width greater than about 1500 mm and a length greater than about 1500 mm, although smaller or larger dimensions are contemplated and possible using, for example a fusion downdraw process such as the fusion downdraw process described herein.

The phase separated glass sheet may have a first phase enriched in SiO₂ and a second phase enriched in B₂O₃. The phase separated glass sheet may be optionally washed prior to subsequent steps. For example, the phase separated glass may be washed in a detergent. An ultrasonic bath may be used for the washing. For example, the phase separated glass may be washed by soaking the phase separated glass in an ultrasonic bath comprising a detergent, for example an aqueous solution comprising 4 wt % Semiclean, for a time in a range from about 2 minutes to about 6 minutes, such as for about 4 minutes.

In a second step, the phase separated glass sheet may be exposed to an etchant, for example an acid suitable for etching the second phase from the glass sheet. The acid may be an aqueous solution comprising an inorganic acid or an organic acid. The acid may be present in an amount from about 5 wt % to about 40 wt %, depending on the acid selected and the amount of secondary phase that should be removed. Suitable inorganic acids may include at least one of HCl, H₂SO₄, HNO₃, HF, or H₃PO₄. Example organic acids may include citric acid and/or acetic acid. The etchant may be at a temperature in a range from about 60° C. to about 100° C., with the exposure time in a range from about 1 hour to about 6 hours, for example in a range from about 2 hours to about 4 hours. The strength of the acid solution and the temperature of the etchant will dictate the length of time suitable to etch away the second phase from the phase separated glass sheet. Removal of the second phase from the phase separated glass sheet produces a porous glass sheet containing predominantly, or entirely, the first (matrix) phase, e.g., the SiO₂-rich phase. Calculated open porosity of the porous glass sheet can be greater than about 28%. Only about 8.7% of the pores had a diameter greater than about 3 nm, meaning the majority of the pores were less than about 3 nm is diameter. A median (d50) pore diameter of pores of the porous glass sheet may be less than about 1 μm, for example less than about 0.5 m, less than about 0.1 μm, less than about 0.05 μm, less than about 0.025 μm, or less than about 0.02 μm. Direct porosity measurements were made using mercury intrusion into the pores. However, this technique is limited to pore sizes in excess of 3 nm. Accordingly, porosity was also calculated based on density.

In an optional subsequent step after the etching, the porous glass article resulting from the etching may be rinsed in deionized water, for example an 18 Mohm deionized water.

The porous glass article resulting from the etching process described above may find separate use in other than electronic applications. For example, because the secondary phase is interconnected, the pores left behind by the etching, which can be quite small (e.g., e.g., less than about 100 nm, less than about 75 nm, less than about 50 nm, less than about 25 nm, or, for example, as small as or less than about 3 nanometers in diameter) and can extend through the thickness of the porous glass sheet. In spite of the porous structure of the porous glass sheet, the porous glass sheet remains transparent. The porous glass sheet may be used for such diverse applications as nano filtration, reverse osmosis, and water treatment applications. Surfaces of the pores may be treated (e.g., coated) such that the porous article may be used in micro-reactor (e.g., nano-reactor) applications (where chemical reactions can be performed at very small scales). The pore surfaces may be coated with a catalyst. In some embodiments, the pores may be impregnated with nano-sized particles to provide additional functionality.

In a third step of the method, the porous glass article can be consolidated by heating the porous glass article to a suitable temperature greater than the glass transition temperature Tg of the glass. Consolidation of the porous glass sheets can stabilize performance of the glass sheet by preventing the uptake of water molecules into the pores. Because water is a highly polarized molecule, moisture in the glass can adversely affect the dielectric properties of the glass. In embodiments, the porous glass article may optionally be preheated to a temperature in a range from about 100° C. to about 300° C. for a time in a range from about 1 hour to about 2 hours to dry the porous glass article prior to consolidation. The dried porous glass article may optionally be further heated to a temperature in a range from about 500° C. to about 700° C., for example at a temperature in a range from about 550° C. to about 650° C., to remove (burn out) any organic contaminants, e.g., carbon, that may have contaminated the porous glass article. Contaminates can include oils from handling, or other environmental contaminants. The dried porous glass article may be heated for a time in a range from about 30 minutes to about 2 hours, for a time in a range from about 45 minutes to about 75 minutes.

To consolidate the porous glass article, the porous glass article may be heated to a consolidation temperature in a range from about 900° C. to about 1100° C., for example in a range from about 920° C. to about 1100° C., or in a range from about 940° C. to about 1100° C., in a range from about 960° C. to about 1100° C., in a range from about 980° C. to about 1100° C., in a range from about 1000° C. to about 1100° C., in a range from about 1020° C. to about 1100° C., in a range from about 1040° C. to about 1100° C., in a range from about 1060° C. to about 1100° C., or in a range from about 1080° C. to about 1100° C., including all ranges and subranges therebetween. The porous glass article may be heated to the consolidation temperature for a time in a range from about 1 hour to about 4 hours, although longer consolidation times are contemplated, for example in a range from about 1 hour to about 24 hours, in a range from about 1 hour to about 20 hours, in a range from about 1 hour to about 16 hours, in a range from about 1 hour to about 12 hours, or in a range from about 1 hour to about 8 hours, including all ranges and subranges therebetween. When heated to the consolidation temperature, pores in the porous glass article close and at least a portion of, or the entirety of, the glass becomes solid, depending on the temperature selected and the amount of consolidation desired. SEM and time of flight (ToF) secondary ion mass spectrometry (SIMS) analysis has shown the porous glass remaining after the etching process is composed primarily of SiO₂ (see Table 2). Dielectric property measurements have shown that once the porous glass is consolidated, Dₖ and D_{f} values are comparable to that of high purity fused silica (HPFS). However, unlike HPFS, a phase separated glass can be drawn, for example via a fusion downdraw process, into large glass sheets, etched, then consolidated to produce a high-silica glass sheet with HPFS-like dielectric properties.

Table 1 illustrates a phase separated glass sample (GS17, see Table 5) etched in accordance with the above etching process using an aqueous acid solution comprising 5 wt % HCl. All samples were 2″×2″ coupons of GS17 (see Table 5), washed with a solution of 4% Semiclean detergent in an ultrasonic bath for 2 minutes at 65° C., then dried in an oven for 1 hour at 110° C. (except trial C, which was not dried). All etching was performed in a solution of 5 wt % HCl at 95° C. For reference, the glass before etching had a Dₖ of 4.6 and a D_{f} of 0.0037. Listed in Table 1 are the trial designation (A-DD), the first heat treatment (1^{st} HT) expressed as temperature (Tp, ° C.)/time (Tm, hours), 2^{nd} heat treatment (2^{nd} HT) expressed as temperature (Tp, ° C.)/time (Tm, hours), first consolidation (1^{st} Con.) expressed as temperature temperature (Tp, ° C.)/time (Tm, hours), second consolidation (2^{nd} Con.) expressed as temperature (Tp, ° C.)/time (Tm, hours), surface treatment with hydrofluoric acid (HF) expressed as “before heat treatment” (B) or “after last consolidation” (A), environmental soak in an 85° C./85% relative humidity environment expressed in time (hours), and the dielectric properties dielectric constant Dₖ, and loss tangent D_{f}. Dielectric constant and loss tangent were measured at 10 GHz, except those including an asterisk. Dielectric properties including an asterisk were measured at 5 GHz (warping of the samples prevented measurement at 10 GHz). Samples comprising an apostrophe (') after the dielectric properties indicates the sample was exposed to a lab environment (72 C, 20% RH) for approximately 24 hours prior to measurement for dielectric properties. Samples including a cross (†) after the dielectric properties were exposed to the lab environment for approximately 60 hours prior to measurement for dielectric properties.

The glass from trial DD was measured for dielectric properties a first time after consolidation, and a second time after an 85° C./85% RH soak. Double dashes indicates a process step was not performed. Accordingly, by way of example, the samples of trials A-C were etched, but not heat treated, consolidated, subjected to an HF treatment, or exposed to an 85 C/85% RH environment prior to measurement for dielectric properties. The data show a distinct decrease in dielectric properties Dₖ and D_{f} when comparing the glass samples of trials A-C with, for example, the glass sample of trial D, which after etching, was simply subjected to heating to a temperature of 200° C. for 1 hour without the benefit of further heating. It is believed this decrease in dielectric properties occurred as a result of removal of moisture from the porous sample obtained after etching. Similarly, the dielectric properties for the glass sample of trial E was further decreased by including a consolidation step, wherein the sample was subjected to a temperature of 820° C. for 1 hour. Similar results can be observed for other samples, wherein the addition of further heating, either through one or more heat treatment steps, or one or more consolidation steps, may result in a decrease in dielectric properties. The glass sample of trial DD is presented on two lines owing to the fact that the sample was measured for Dₖ and D_{f} after etching and consolidation (including an HF treatment of the porous glass article before consolidation), and then measured a second time after the consolidated glass article was exposed to an 85° C./85% RH environment for 24 hours. The values for Dₖ and D_{f} both before and after the 85° C./85% RH exposure are remarkably consistent, showing stable dielectric properties even in the presence of moisture.

TABLE 1

| | Etch | 1^{st} HT | 2^{nd} HT | 1^{st} Con. | 2^{nd} Con. | | 85° C./ | | |
|---|---|---|---|---|---|---|---|---|---|
| | time | Tp/Tm | Tp/Tm | Tp/Tm | Tp/Tm | HF | 85RH | | |
| | (hrs) | (° C./hrs) | (° C./hrs) | (° C./hrs) | (° C./hrs) | Treat | (hrs) | Dₖ | D_{f} |
| A | 16 | — | — | — | — | — | — | 4.47 | 0.067 |
| B | 24 | — | — | — | — | — | — | 4.38 | 0.065 |
| C | 24 | — | — | — | — | — | — | 4.4 | 0.076 |
| D | 24 | 620/2 | 2 | — | — | — | — | 3.43 | 0.02 |
| E | 24 | 620/2 | 2 | 820/2 | — | — | — | 3.31 | 0.01 |
| F | 24 | — | — | 820/2 | 960/2 | — | — | 3.44 | 0.0012 |
| G | 24 | — | — | 960/2 | — | — | | 3.63* | 0.001* |
| H | 24 | — | — | 960/2 | — | | | 3.63 | 0.0018 |
| I | 24 | — | — | 960/4 | — | | | 3.69′ | 0.0064′ |
| J | 24 | 200/1 | 600/1 | 960/4 | — | | | 3.68 | 0.0046 |
| K | 24 | 200/1 | 600/1 | 960/4 | — | B | — | 3.65 | 0.0012 |
| L | 24 | 200/1 | 600/1 | 960/4 | — | A | — | 3.68 | 0.0061 |
| M | 24 | 200/1 | 600/1 | 960/4 | — | — | 4 | 3.72 | 0.0073 |
| N | 24 | — | — | 960/12 | — | — | — | 3.63* | 0.001* |
| O | 24 | — | — | 960/12 | — | — | — | 3.62*† | 0.0013*† |
| P | 24 | 200/1 | 600/1 | 1000/2 | — | — | — | 3.78 | 0.0016 |
| Q | 24 | 200/1 | 600/1 | 1000/2 | — | B | — | 3.8 | 0.0011 |
| R | 24 | 200/1 | 600/1 | 1000/2 | — | — | — | 3.82† | 0.00289† |
| S | 24 | 200/1 | 600/1 | 1000/2 | — | B | — | 3.79† | 0.00169† |
| T | 24 | — | — | 1000/4 | — | — | — | 3.62* | 0.00091* |
| U | 24 | — | — | 1000/4 | — | — | — | 3.69*† | 0.00163*† |
| V | 24 | — | — | 1040/2 | — | — | — | 3.69* | 0.00045* |
| W | 16 | — | — | 1040/2 | — | — | — | 3.74* | 0.00048* |
| X | 24 | — | — | 1040/2 | — | — | — | 3.67* | 0.00059*′ |
| Y | 16 | — | — | 1040/2 | — | — | — | 3.74* | 0.00053*′ |
| Z | 24 | — | — | 1040/2 | — | — | — | 3.81* | 0.00058*† |
| AA | 16 | — | — | 1040/2 | — | — | — | 3.85* | 0.00056*† |
| BB | 24 | — | — | 1040/2 | — | — | 24 | 3.7* | 0.00176* |
| CC | 16 | — | — | 1040/2 | — | — | 24 | 3.89* | 0.00102* |
| DD | 24 | 200/1 | 600/1 | 1040/4 | — | B | — | 3.81 | 0.00085 |

| | | | | |
|---|---|---|---|---|
| DD | Second measurement taken after 85° C./85% RH | 24 | 3.77 | 0.000786 |

Table 2 lists the before and after composition of a fusion formed GS17 glass sample before and after etching in 5 wt % HCl at 95° C. Composition analysis was performed with ToF SIMS to accurately estimate the remaining glass composition after HCl etching. The analysis was performed with 500 micrometer×500 micrometer field of view across the entire thickness of the sample. The before compositional constituents reflect total amounts (including both phases of the phase separated glass sample). All constituent amounts are given in mol %. The data show a significant increase in the proportional amount of SiO₂ after a significant portion of the boron-rich secondary phase was removed from the sample, resulting in a near pure SiO₂ sheet that would have been impossible to form via a fusion downdraw process. There was no indication that a composition gradient existed. It is expected that other phase separated glass compositions described herein will provide similar after-etching results.

TABLE 2

| Constituent | GS17 before etching | GS17 after etching |
|---|---|---|
| SiO₂ | 68.82 | 96.8 |
| Al₂O₃ | 7.66 | 0.62 |
| B₂O₃ | 13.91 | 2.19 |
| MgO | 5.52 | 0.14 |
| CaO | 3.90 | 0.24 |
| SrO | 0.03 | |
| SnO₂ | 0.08 | 0.08 |

Tables 3-9 below illustrate exemplary phase separated glasses according to the present disclosure, in mole percent (mol %), as calculated on an oxide basis from the as-batched glasses (the glass precursor composition from which the glass is derived). The glass samples were batched and drawn in a production fusion draw apparatus as glass ribbon and separated into glass sheets having dimension 1500 millimeters (mm)×1850 mm. Phase separation was determined by SEM. The glass sheets had a thickness of 0.7 mm.

TABLE 3

| Glass Sample | GS1 | GS2 | GS3 | GS4 | GS5 | GS6 | GS7 | GS8 |
|---|---|---|---|---|---|---|---|---|
| SiO₂ | 68.26 | 68.23 | 68.14 | 68.22 | 68.26 | 68.34 | 68.39 | 68.48 |
| Al₂O₃ | 8.64 | 8.57 | 8.55 | 8.49 | 8.47 | 8.41 | 8.39 | 8.33 |
| B₂O₃ | 11.95 | 12.08 | 12.17 | 12.2 | 12.28 | 12.38 | 12.42 | 12.54 |
| K₂O | 0 | 0 | 0 | 0 | 0 | 0 | 0 | 0 |
| Na₂O | 0.03 | 0.03 | 0.03 | 0.03 | 0.03 | 0.03 | 0.03 | 0.03 |
| MgO | 4.87 | 4.95 | 4.99 | 4.98 | 4.92 | 4.81 | 4.77 | 4.68 |
| CaO | 5.94 | 5.85 | 5.84 | 5.79 | 5.76 | 5.74 | 5.72 | 5.67 |
| SrO | 0.18 | 0.17 | 0.17 | 0.16 | 0.16 | 0.16 | 0.16 | 0.15 |
| BaO | 0 | 0 | 0 | 0 | 0 | 0 | 0 | 0 |
| SnO₂ | 0.08 | 0.08 | 0.08 | 0.08 | 0.08 | 0.08 | 0.08 | 0.08 |
| Fe₂O₃ | 0 | 0 | 0 | 0 | 0 | 0 | 0 | 0 |
| TiO₂ | 0.01 | 0.01 | 0.01 | 0.01 | 0.01 | 0.01 | 0.01 | 0.01 |
| ZnO | 0 | 0 | 0 | 0 | 0 | 0 | 0 | 0 |
| ZrO₂ | 0.03 | 0.03 | 0.03 | 0.03 | 0.03 | 0.03 | 0.03 | 0.03 |
| La₂O₃ | 0 | 0 | 0 | 0 | 0 | 0 | 0 | 0 |
| Y₂O₃ | 0 | 0 | 0 | 0 | 0 | 0 | 0 | 0 |
| Li₂O | 0 | 0 | 0 | 0 | 0 | 0 | 0 | 0 |
| Dₖ@10 GHz | | | | | | | | |
| D_{f}@10 GHz | | | | | | | | |

TABLE 4

| Glass Sample | GS9 | GS10 | GS11 | GS12 | GS13 | GS14 | GS15 | GS16 |
|---|---|---|---|---|---|---|---|---|
| SiO₂ | 68.63 | 68.72 | 68.76 | 68.85 | 68.91 | 68.81 | 68.88 | 68.75 |
| Al₂O₃ | 8.26 | 8.14 | 8.05 | 7.9 | 7.84 | 7.83 | 7.7 | 7.63 |
| B₂O₃ | 12.66 | 12.95 | 13.19 | 13.42 | 13.52 | 13.68 | 13.8 | 14.02 |
| K₂O | 0 | 0 | 0 | 0 | 0 | 0 | 0 | 0 |
| Na₂O | 0.03 | 0.03 | 0.03 | 0.03 | 0.03 | 0.03 | 0.03 | 0.03 |
| MgO | 4.54 | 4.4 | 4.48 | 4.84 | 5.06 | 5.19 | 5.43 | 5.57 |
| CaO | 5.62 | 5.53 | 5.27 | 4.78 | 4.48 | 4.29 | 4.01 | 3.85 |
| SrO | 0.14 | 0.11 | 0.09 | 0.06 | 0.04 | 0.04 | 0.03 | 0.02 |
| BaO | 0 | 0 | 0 | 0 | 0 | 0 | 0 | 0 |
| SnO₂ | 0.08 | 0.08 | 0.08 | 0.08 | 0.08 | 0.08 | 0.08 | 0.08 |
| Fe₂O₃ | 0 | 0 | 0 | 0 | 0 | 0 | 0 | 0 |
| TiO₂ | 0.01 | 0.01 | 0.01 | 0.01 | 0.01 | 0.01 | 0.01 | 0.01 |
| ZnO | 0 | 0 | 0 | 0 | 0 | 0 | 0 | 0 |
| ZrO₂ | 0.03 | 0.03 | 0.03 | 0.03 | 0.03 | 0.03 | 0.04 | 0.04 |
| La₂O₃ | 0 | 0 | 0 | 0 | 0 | 0 | 0 | 0 |
| Y₂O₃ | 0 | 0 | 0 | 0 | 0 | 0 | 0 | 0 |
| Li₂O | 0 | 0 | 0 | 0 | 0 | 0 | 0 | 0 |
| Dₖ@10 GHz | | | | | | | | |
| D_{f}@10 GHz | | | | | | | | |

TABLE 5

| Glass Sample | GS17 | GS18 | GS19 | GS20 | GS21 | GS22 | GS23 | GS24 |
|---|---|---|---|---|---|---|---|---|
| SiO₂ | 68.82 | 68.82 | 68.82 | 68.82 | 68.82 | 68.82 | 68.82 | 68.82 |
| Al₂O₃ | 7.66 | 9.66 | 10.16 | 11.16 | 7.66 | 7.66 | 7.66 | 7.66 |
| B₂O₃ | 13.91 | 11.91 | 11.41 | 10.41 | 13.91 | 13.91 | 13.91 | 13.91 |
| K₂O | 0 | 0 | 0 | 0 | 0 | 0 | 0 | 0 |
| Na₂O | 0.03 | 0.03 | 0.03 | 0.03 | 0.03 | 0.03 | 0.03 | 0.03 |
| MgO | 5.52 | 5.52 | 5.52 | 5.52 | 3.53 | 3.33 | 3.03 | 5.52 |
| CaO | 3.90 | 3.90 | 3.90 | 3.90 | 5.90 | 6.10 | 6.40 | 3.40 |
| SrO | 0.03 | 0.03 | 0.03 | 0.03 | 0.03 | 0.03 | 0.03 | 0.03 |
| BaO | 0 | 0 | 0 | 0 | 0 | 0 | 0 | 0.50 |
| SnO₂ | 0.08 | 0.08 | 0.08 | 0.08 | 0.08 | 0.08 | 0.08 | 0.08 |
| Fe₂O₃ | 0 | 0 | 0 | 0 | 0 | 0 | 0 | 0 |
| TiO₂ | 0 | 0 | 0 | 0 | 0 | 0 | 0 | 0 |
| ZnO | 0 | 0 | 0 | 0 | 0 | 0 | 0 | 0 |
| ZrO₂ | 0 | 0 | 0 | 0 | 0 | 0 | 0 | 0 |
| La₂O₃ | 0 | 0 | 0 | 0 | 0 | 0 | 0 | 0 |
| Y₂O₃ | 0 | 0 | 0 | 0 | 0 | 0 | 0 | 0 |
| Li₂O | 0 | 0 | 0 | 0 | 0 | 0 | 0 | 0 |
| Dₖ@10 GHz | | | | | | | | |
| D_{f}@10 GHz | | | | | | | | |

TABLE 6

| Glass Sample | GS25 | GS26 | GS27 | GS28 | GS29 | GS30 | GS31 |
|---|---|---|---|---|---|---|---|
| SiO₂ | 68.82 | 68.82 | 68.82 | 68.82 | 68.82 | 68.82 | 68.82 |
| Al₂O₃ | 7.66 | 7.66 | 11.16 | 11.50 | 11.75 | 5.00 | 3.00 |
| B₂O₃ | 13.91 | 13.91 | 10.41 | 10.07 | 9.82 | 13.91 | 13.91 |
| K₂O | 0 | 0 | 0 | 0 | 0 | 0 | 0 |
| Na₂O | 0 | 0 | 0 | 0 | 0 | 0 | 0 |
| MgO | 5.52 | 5.02 | 5.52 | 5.52 | 5.52 | 5.52 | 5.52 |
| CaO | 2.90 | 3.90 | 3.90 | 3.90 | 3.90 | 6.56 | 8.56 |
| SrO | 0.03 | 0.03 | 0.03 | 0.03 | 0.03 | 0.03 | 0.03 |
| BaO | 1.00 | 0.50 | 0.00 | 0.00 | 0.00 | 0.00 | 0.00 |
| SnO₂ | 0.08 | 0.08 | 0.08 | 0.08 | 0.08 | 0.08 | 0.08 |
| Fe₂O₃ | 0 | 0 | 0 | 0 | 0 | 0 | 0 |
| TiO₂ | 0 | 0 | 0 | 0 | 0 | 0 | 0 |
| ZnO | 0 | 0 | 0 | 0 | 0 | 0 | 0 |
| ZrO₂ | 0.03 | 0.03 | 0.03 | 0.03 | 0.03 | 0.03 | 0.03 |
| La₂O₃ | 0 | 0 | 0 | 0 | 0 | 0 | 0 |
| Y₂O₃ | 0 | 0 | 0 | 0 | 0 | 0 | 0 |
| Li₂O | 0 | 0 | 0 | 0 | 0 | 0 | 0 |
| Dₖ@10 GHz | | | | | | | |
| D_{f}@10 GHz | | | | | | | |

TABLE 7

| Glass Sample | GS32 | GS33 | GS34 | GS35 | GS36 | GS37 | GS38 | GS39 |
|---|---|---|---|---|---|---|---|---|
| SiO₂ | 68.82 | 68.32 | 68.00 | 68.07 | 67.57 | 67.57 | 67.57 | 67.57 |
| Al₂O₃ | 11.00 | 11.00 | 11.00 | 12.50 | 13.00 | 13.00 | 11.00 | 9.00 |
| B₂O₃ | 9.82 | 9.82 | 9.82 | 9.82 | 9.82 | 9.82 | 13.82 | 16.00 |
| K₂O | 0 | 0 | 0 | 0 | 0 | 0 | 0 | 0 |
| Na₂O | 0.03 | 0.03 | 0.03 | 0.03 | 0.03 | 0.03 | 0.03 | 0.03 |
| MgO | 5.52 | 5.52 | 5.84 | 5.52 | 5.52 | 2.33 | 0.00 | 0.00 |
| CaO | 4.65 | 5.15 | 5.15 | 3.90 | 3.90 | 7.12 | 1.57 | 1.57 |
| SrO | 0.03 | 0.03 | 0.03 | 0.03 | 0.03 | 0.00 | 5.55 | 5.55 |
| BaO | 0.00 | 0.00 | 0.00 | 0.00 | 0.00 | 0.00 | 0.33 | 0.33 |
| SnO₂ | 0.08 | 0.08 | 0.08 | 0.08 | 0.08 | 0.08 | 0.08 | 0.08 |
| Fe₂O₃ | 0 | 0 | 0 | 0 | 0 | 0 | 0 | 0 |
| TiO₂ | 0 | 0 | 0 | 0 | 0 | 0 | 0 | 0 |
| ZnO | 0 | 0 | 0 | 0 | 0 | 0 | 0 | 0 |
| ZrO₂ | 0 | 0 | 0 | 0 | 0 | 0 | 0 | 0 |
| La₂O₃ | 0 | 0 | 0 | 0 | 0 | 0 | 0 | 0 |
| Y₂O₃ | 0 | 0 | 0 | 0 | 0 | 0 | 0 | 0 |
| Li₂O | 0 | 0 | 0 | 0 | 0 | 0 | 0 | 0 |
| Dₖ@10 GHz | | | | | | | 4.92 | 4.77 |
| D_{f}@10 GHz | | | | | | | 0.0034 | 0.0029 |

TABLE 8

| Glass Sample | GS40 | GS41 | GS42 | GS43 | GS44 | GS45 | GS46 | GS47 |
|---|---|---|---|---|---|---|---|---|
| SiO₂ | 67.57 | 67.57 | 67.57 | 67.57 | 67.57 | 67.29 | 67.57 | 63.65 |
| Al₂O₃ | 13.00 | 9.00 | 13.00 | 13.00 | 13.00 | 12.95 | 13.00 | 11.00 |
| B₂O₃ | 11.82 | 11.82 | 11.82 | 11.82 | 11.82 | 11.77 | 11.82 | 17.82 |
| K₂O | 0 | 0 | 0 | 0 | 0 | 0 | 0 | 0 |
| Na₂O | 0 | 0 | 0 | 0 | 0 | 0 | 0 | 0 |
| MgO | 1.57 | 0.00 | 0.00 | 0.00 | 0.00 | 0.00 | 0.00 | 0.00 |
| CaO | 0.00 | 4.57 | 0.00 | 1.57 | 1.57 | 1.56 | 1.57 | 1.57 |
| SrO | 5.55 | 6.55 | 5.55 | 2.78 | 2.78 | 5.53 | 5.05 | 5.55 |
| BaO | 0.33 | 0.33 | 0.00 | 0.33 | 0.33 | 0.33 | 0.33 | 0.33 |
| SnO₂ | 0.08 | 0.08 | 0.08 | 0.08 | 0.08 | 0.08 | 0.08 | 0.08 |
| Fe₂O₃ | 0 | 0 | 0 | 0 | 0 | 0 | 0 | 0 |
| TiO₂ | 0 | 0 | 0 | 0 | 0 | 0 | 0 | 0 |
| ZnO | 0 | 0 | 1.90 | 0 | 0 | 0 | 0 | 0 |
| ZrO₂ | 0 | 0 | 0 | 0 | 0 | 0 | 0 | 0 |
| La₂O₃ | 0 | 0 | 0 | 2.78 | 0 | 0 | 0 | 0 |
| Y₂O₃ | 0 | 0 | 0 | 0 | 2.78 | 0 | 0 | 0 |
| Li₂O | 0 | 0 | 0 | 0 | 0 | 0.50 | 0.50 | 0 |
| Dₖ@10 GHz | 5.04 | 5.27 | 4.98 | 5.36 | 5.25 | 5.12 | 5.05 | 4.93 |
| D_{f}@10 GHz | 0.0039 | 0.0038 | 0.0036 | 0.0033 | 0.0033 | 0.004 | 0.0039 | 0.0030 |

TABLE 9

| Glass Sample | GS48 | GS49 | GS50 | GS51 | GS52 | GS53 |
|---|---|---|---|---|---|---|
| SiO₂ | 61.65 | 61.65 | 59.65 | 62.65 | 63.65 | 61.65 |
| Al₂O₃ | 11 | 11 | 11 | 10 | 10 | 11.00 |
| B₂O₃ | 17.82 | 17.82 | 19.82 | 18.82 | 17.82 | 17.82 |
| K₂O | 0 | 0 | 0 | 0 | 0 | 0 |
| Na₂O | 0 | 0 | 0 | 0 | 0 | 0 |
| MgO | 0.00 | 0 | 0 | 0 | 0 | 3.57 |
| CaO | 3.57 | 3.57 | 3.57 | 3.07 | 3.07 | 0.00 |
| SrO | 3.55 | 4.05 | 5.55 | 5.05 | 5.05 | 5.55 |
| BaO | 0.33 | 0.33 | 0.33 | 0.33 | 0.33 | 0.33 |
| SnO₂ | 0.08 | 0.08 | 0.08 | 0.08 | 0.08 | 0.08 |
| Fe₂O₃ | 0 | 0 | 0 | 0 | 0 | 0 |
| TiO₂ | 0 | 0 | 0 | 0 | 0 | 0 |
| ZnO | 2.00 | 0 | 0 | 0 | 0 | 0 |
| ZrO₂ | 0 | 0 | 0 | 0 | 0 | 0 |
| La₂O₃ | 0 | 1.5 | 0 | 0 | 0 | 0 |
| Y₂O₃ | 0 | 0 | 0 | 0 | 0 | 0 |
| Li₂O | 0 | 0 | 0 | 0 | 0 | 0 |
| Dₖ@10 GHz | 4.97 | 5.27 | 5.06 | 4.90 | 4.91 | 4.99 |
| D_{f}@10 GHz | 0.0032 | 0.0034 | 0.0032 | 0.0030 | 0.0030 | 0.0034 |

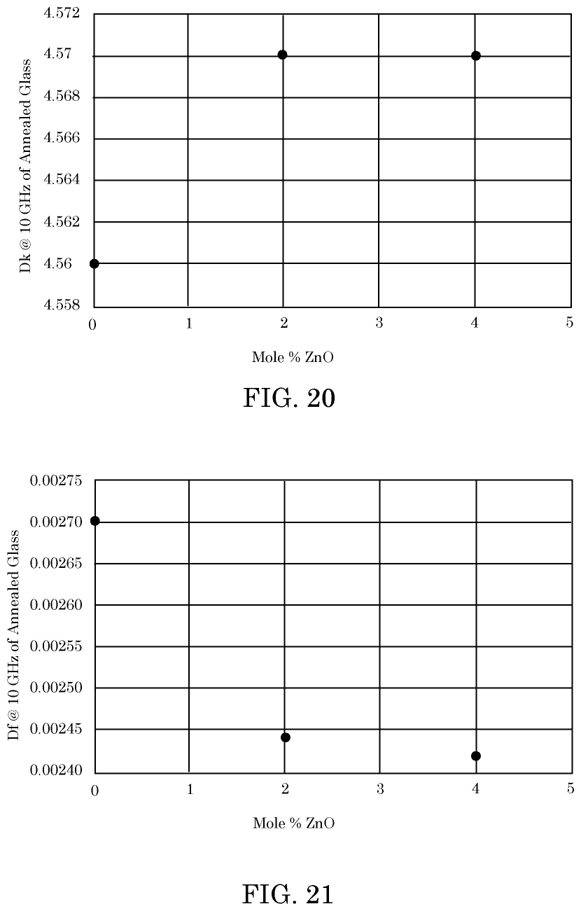

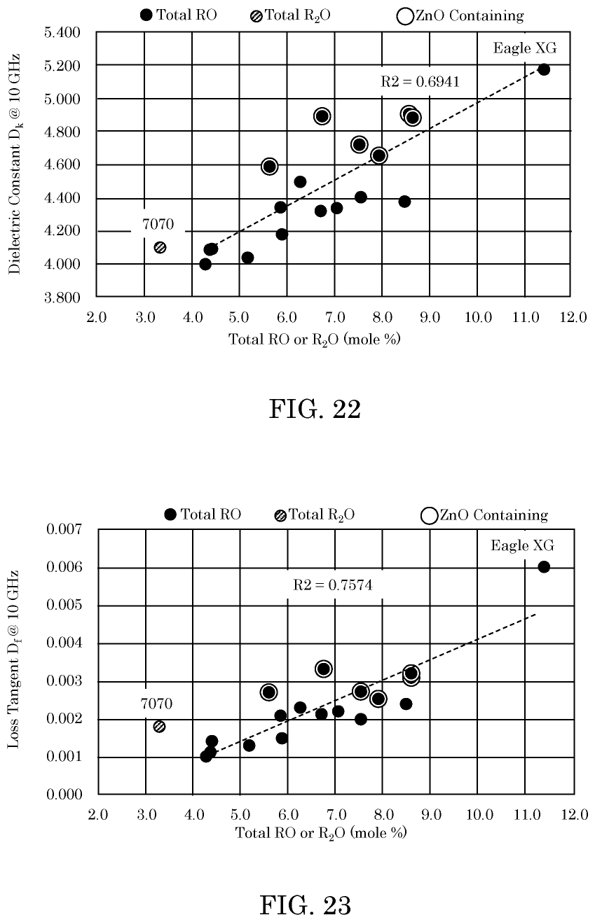

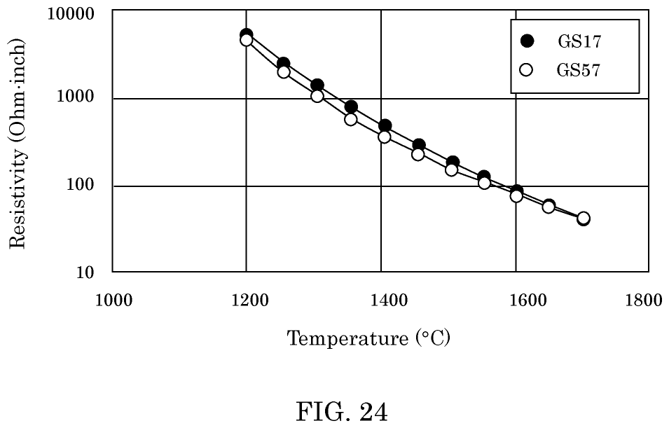

To obtain low dielectric constant (Dₖ) and dielectric loss tangent (D_{f}) and increased durability in glass, several different oxides were investigated. Table 10 and Table 11 list compositions and measured Dₖ and D_{f} data for glasses with ZnO additions. FIG. 20 and FIG. 21 are plots showing the impact on Dₖ and D_{f} of replacing MgO with ZnO in GS17. As can be seen in the plots, Dₖ increased with an addition of ZnO for MgO and D_{f} decreased with an addition of ZnO. However, when ZnO is added as a replacement for B₂O₃ in the glass the Dₖ and D_{f} properties did not appear to change. This is shown in FIGS. 22 and 23. In FIG. 22 and FIG. 23 the open circles are glasses with ZnO replacing B₂O₃ and as can be seen the open circles overlay the black circles which are the same glasses without ZnO. This indicates Dₖ and D_{f} are impacted by the B₂O₃ content but not at all by the ZnO content. These data indicate ZnO is a good option for further lowering the D_{f} of the glass or retaining the same Dₖ and D_{f} while potentially improving the meltability of the glass by reducing the resistivity, which is related to the B₂O₃ content in these types of glasses. The glass melt resistivity of GS57, which has approximately 4 mol % of ZnO, is shown in FIG. 24. It is evident glass sample GS57 has lower resistivity compared to glass sample GS17. Note that GS57 has no CaO whereas GS17 has approximately 5 mol % of CaO. The fact that GS17 shows low resistivity without CaO indicates the effectiveness of ZnO in lowering resistivity, and thereby improving meltability.

TABLE 10

| Glass Sample | GS54 | GS55 | GS56 | GS57 | GS58 | GS659 | GS60 | GS61 | GS62 |
|---|---|---|---|---|---|---|---|---|---|
| SiO₂ | 68.95 | 68.80 | 68.00 | 68.47 | 68.16 | 69.92 | 66.60 | 66.62 | 57.00 |
| Al₂O₃ | 6.93 | 6.70 | 6.73 | 8.67 | 7.71 | 7.92 | 10.47 | 6.68 | 4.77 |
| B₂O₃ | 13.29 | 13.19 | 11.27 | 11.72 | 11.29 | 13.15 | 12.37 | 12.35 | 14.28 |
| K₂O | 0 | 0 | 0 | 0 | 0 | 0 | 0 | 0 | |
| Na₂O | 0 | 0 | 0 | 0 | 0 | 0 | 0 | 0 | |
| MgO | 2.73 | 3.23 | 3.57 | 3.71 | 3.58 | 4.31 | 2.91 | 4.78 | 9.59 |
| CaO | 4.84 | 3.71 | 3.96 | 0 | 3.97 | 0 | 0 | 0 | 0 |
| SrO | 0 | 0 | 0 | 0 | 0 | 0 | 0 | 0 | 0 |
| BaO | 0 | 1.06 | 1.15 | 3.15 | 1.15 | 1.37 | 2.83 | 4.75 | 9.52 |
| SnO₂ | 0.09 | 0.09 | 0.09 | 0.09 | 0.09 | 0.09 | 0.10 | 0.10 | 0.10 |
| Fe₂O₃ | 0 | 0 | 0 | 0 | 0 | 0 | 0 | 0 | |
| TiO₂ | 0 | 0 | 0 | 0 | 0 | 0 | 0 | 0 | |
| ZnO | 3.16 | 3.20 | 5.22 | 4.18 | 4.03 | 3.24 | 4.74 | 4.73 | 4.75 |
| ZrO₂ | 0 | 0 | 0 | 0 | 0 | 0 | 0 | 0 | |
| La₂O₃ | 0 | 0 | 0 | 2.78 | 0 | 0 | 0 | 0 | |
| Y₂O₃ | 0 | 0 | 0 | 0 | 2.78 | 0 | 0 | 0 | |
| Li₂O | 0 | 0 | 0 | 0 | 0 | 0.50 | 0.50 | 0 | |
| Dₖ@10 GHz | 4.71 | 4.66 | 4.91 | 4.89 | 4.88 | 4.59 | 4.9 | 5.07 | 6.31 |
| D_{f}@10 GHz | 0.0027 | 0.0025 | 0.0031 | 0.0033 | 0.0032 | 0.0027 | 0.0034 | 0.0038 | 0.0049 |

TABLE 11

| Glass Sample | GS63 | GS64 | GS65 | GS66 | GS67 | GS68 | GS69 | GS70 | GS71 |
|---|---|---|---|---|---|---|---|---|---|
| SiO₂ | 68.47 | 68.47 | 68.47 | 67.39 | 67.84 | 68.80 | 67.07 | 68.80 | 68.80 |
| Al₂O₃ | 8.67 | 8.67 | 8.67 | 8.52 | 8.61 | 6.70 | 6.94 | 7.59 | 7.59 |
| B₂O₃ | 11.72 | 11.72 | 11.72 | 11.47 | 12.52 | 15.19 | 15.02 | 14.10 | 14.10 |
| K₂O | 0 | 0 | 0 | 0 | 0 | 0 | 0 | 0 | 0 |
| Na₂O | 0 | 0 | 0 | 0 | 0 | 0 | 0 | 0 | 0 |
| MgO | 3.71 | 3.71 | 3.71 | 7.46 | 5.84 | 3.53 | | 3.55 | 1.55 |
| CaO | 0 | 0 | 0 | 0.05 | 0.05 | 3.43 | 0 | 3.84 | 3.84 |
| SrO | 0 | 0 | 0 | 0 | 0 | 1.06 | 3.93 | 0 | 0 |
| BaO | 3.15 | 1.58 | 0 | 2.96 | 2.98 | 0 | 3.93 | 0 | 0 |
| SnO₂ | 0.10 | 0.10 | 0.10 | 0.10 | 0.10 | 0.09 | 0.11 | 0.08 | 0.08 |
| Fe₂O₃ | 0 | 0 | 0 | 0 | 0 | 0 | 0 | 0 | 0 |
| TiO₂ | 0 | 0 | 0 | 0 | 0 | 0 | 0 | 0 | 0 |
| ZnO | 4.18 | 5.76 | 7.34 | 2.04 | 2.06 | 1.20 | 3.00 | 2.00 | 4.00 |
| ZrO₂ | 0 | 0 | 0 | 0 | 0 | 0 | 0 | 0 | 0 |
| La₂O₃ | 0 | 0 | 0 | 0 | 0 | 0 | 0 | 0 | 0 |
| Y₂O₃ | 0 | 0 | 0 | 0 | 0 | 0 | 0 | 0 | 0 |
| Li₂O | 0 | 0 | 0 | 0 | 0 | 0 | 0 | 0 | 0 |
| Dₖ@10 GHz | 4.9 | 4.76 | 4.64 | 4.9 | 4.94 | 4.57 | 5.1 | 4.57 | 4.57 |
| D_{f}@10 GHz | 0.0036 | 0.0033 | 0.0029 | 0.0037 | 0.0036 | 0.0025 | 0.0031 | 0.0024 | 0.0024 |

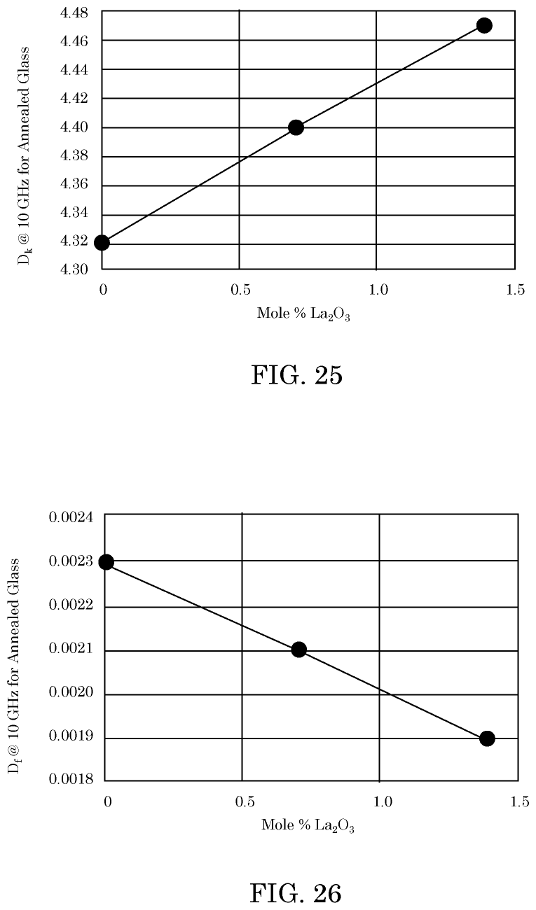

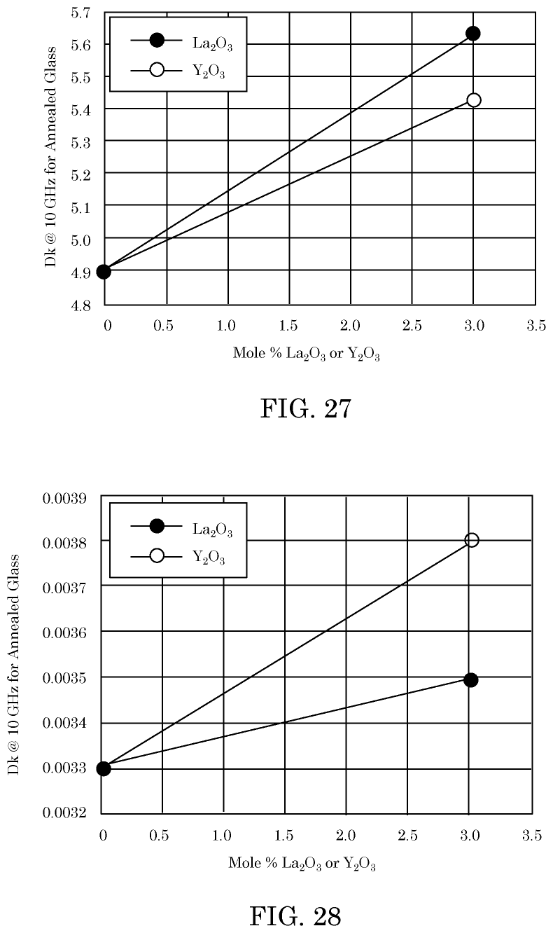

Rare-Earth oxides have shown potential for lowering the D_{f} of a glass. Table 12 provides compositions for several glasses made with additions of La₂O₃ or Y₂O₃ and the Dₖ and D_{f} data for those glasses measured at 10 GHz. FIG. 25 and FIG. 26 are plots of Dₖ and D_{f}, respectively, as a function of mole % La₂O₃ in a glass that has substituted La for Ba. The plots clearly show that as La₂O₃ increases in the glass at the expense of BaO, Dₖ increases and D_{f} decreases. However, when La₂O₃ or Y₂O₃ are added on top of a glass composition (not substituted for a particular oxide) Dₖ and D_{f} both increase over that of the parent glass that did not contain the rare earth element. FIGS. 27 and 28 show the increase in both Dₖ and D_{f} for an La₂O₃ and Y₂O₃-containing glass, where the rare-earth oxide was in addition to the base glass composition (the La₂O₃ and/or Y₂O₃ was not a substitution for another constituent). The data indicate that to lower the D_{f} of a glass, the rare-earth oxide should instead be added as a substitution for one of the larger alkaline-earth oxides in the glass.

TABLE 12

| Glass | GS72 | GS73 | GS74 | GS75 | GS76 | GS77 | GS78 | GS79 | GS80 |
|---|---|---|---|---|---|---|---|---|---|
| SiO₂ | 70.89 | 70.40 | 70.40 | 69.14 | 67.07 | 67.07 | 68.80 | 67.07 | 67.07 |
| Al₂O₃ | 7.06 | 7.00 | 7.00 | 7.16 | 6.94 | 6.94 | 7.59 | 6.94 | 6.94 |
| B₂O₃ | 16.08 | 16.65 | 16.65 | 15.49 | 15.02 | 15.02 | 14.10 | 15.02 | 15.02 |
| K₂O | 0 | 0 | 0 | 0 | 0 | 0 | 0 | 0 | 0 |
| Na₂O | 0 | 0 | 0 | 0 | 0 | 0 | 0 | 0 | 0 |
| MgO | 4.43 | 4.47 | 4.47 | 0 | 0 | 0 | 2.55 | 0 | 0 |
| CaO | 0.04 | 0 | 0 | 0 | 0 | 0 | 3.84 | 3.93 | 3.93 |
| SrO | 0.04 | 0 | 0 | 4.05 | 3.93 | 3.93 | 0 | 0 | 3.93 |
| BaO | 1.35 | 0.69 | 0.00 | 4.05 | 3.93 | 3.93 | 0 | 3.93 | 0 |
| SnO₂ | 0.11 | 0.10 | 0.10 | 0.11 | 0.11 | 0.11 | 0.08 | 0.11 | 0.11 |
| Fe₂O₃ | 0 | 0 | 0 | 0 | 0 | 0 | 0 | 0 | 0 |
| TiO₂ | 0 | 0 | 0 | 0 | 0 | 0 | 0 | 0 | 0 |
| ZnO | 4.18 | 5.76 | 7.34 | 2.04 | 2.06 | 1.20 | 3.00 | 2.00 | 4.00 |
| ZrO₂ | 0 | 0 | 0 | 0 | 0 | 0 | 0 | 0 | 0 |
| La₂O₃ | 0 | 0.70 | 1.39 | 0 | 0 | 3.00 | 3.00 | 0 | 0 |
| Y₂O₃ | 0 | 0 | 0 | 0 | 3.00 | 0 | 0 | 3.00 | 3.00 |
| Li₂O | 0 | 0 | 0 | 0 | 0 | 0 | 0 | 0 | 0 |
| Dₖ@10 GHz | 4.32 | 4.4 | 4.47 | 4.9 | 5.43 | 5.63 | 5.08 | 5.38 | 5.23 |
| D_{f}@10 GHz | 0.0021 | 0.002 | 0.0019 | 0.0033 | 0.0038 | 0.0035 | 0.0027 | 0.0039 | 0.0035 |

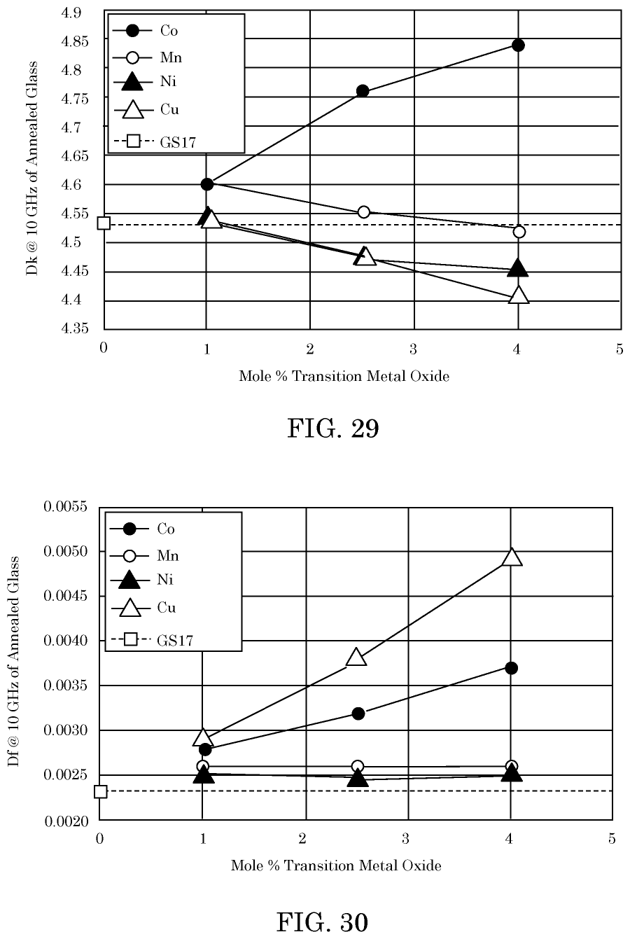

Transition metals (e.g., Co, Mn, Ni, Cu) have relatively low polarizabilities compared to other metal oxides so it was believed this should result in a reduction in either one or both Dₖ and D_{f} of a glass. Table 13 and Table 14 list compositions of several glasses with various transition metal oxide additions and the resulting measured Dₖ and D_{f} at 10 GHz for each of those glasses. The data indicate transition metals (with the exception of Co) provide a means of decreasing Dₖ in an alkaline-earth alumino-borosilicate glass when substituted for CaO, as shown in FIG. 29. However, the data shown in FIG. 30 indicate the transition metals may not lower the D_{f} of the glass but may cause the D_{f} to remain substantially constant or increase compared to the parent glass. Transition metals may also be used to color the glass.

TABLE 13

| Glass | GS81 | GS82 | GS83 | GS84 | GS85 | GS86 | GS87 | GS88 | GS89 |
|---|---|---|---|---|---|---|---|---|---|
| SiO₂ | 68.65 | 68.65 | 68.65 | 68.65 | 68.65 | 68.65 | 68.65 | 68.65 | 68.65 |
| Al₂O₃ | 7.61 | 7.61 | 7.61 | 7.61 | 7.61 | 7.61 | 7.61 | 7.61 | 7.61 |
| B₂O₃ | 14.65 | 14.65 | 14.65 | 14.65 | 14.65 | 14.65 | 14.65 | 14.65 | 14.65 |
| K₂O | 0 | 0 | 0 | 0 | 0 | 0 | 0 | 0 | 0 |
| Na₂O | 0 | 0 | 0 | 0 | 0 | 0 | 0 | 0 | 0 |
| MgO | 3.59 | 3.59 | 3.59 | 3.59 | 3.59 | 3.59 | 3.59 | 3.59 | 3.59 |
| CaO | 0.04 | 0 | 0 | 0 | 0 | 0 | 3.84 | 3.93 | 3.93 |
| CuO | 0 | 0 | 0 | 0 | 0 | 0 | 1.00 | 2.50 | 4.00 |
| NiO | 0 | 0 | 0 | 0 | 0 | 0 | 0 | 0 | 0 |
| Co₃O₄ | 0 | 0 | 0 | 1.00 | 2.50 | 4.00 | 0 | 0 | 0 |
| MnO₂ | 1.00 | 2.50 | 4.00 | 0 | 0 | 0 | 0 | 0 | 0 |
| SnO₂ | 0.11 | 0.11 | 0.11 | 0.11 | 0.11 | 0.11 | 1.11 | 0.11 | 0.11 |
| Dₖ@10 GHz | 4.6 | 4.55 | 4.52 | 4.6 | 4.76 | 4.84 | 4.53 | 4.47 | 4.4 |
| D_{f}@10 GHz | 0.0026 | 0.0026 | 0.0026 | 0.0028 | 0.0032 | 0.0037 | 0.0029 | 0.0038 | 0.0049 |

TABLE 14

| Glass | GS90 | GS91 | GS92 |
|---|---|---|---|
| SiO₂ | 68.65 | 68.65 | 68.65 |
| Al₂O₃ | 7.61 | 7.61 | 7.61 |
| B₂O₃ | 14.65 | 14.65 | 14.65 |
| K₂O | 0 | 0 | 0 |
| Na₂O | 0 | 0 | 0 |
| MgO | 3.59 | 3.59 | 3.59 |
| CaO | 0.04 | 0 | 0 |
| CuO | 0 | 0 | 0 |
| NiO | 1.00 | 2.50 | 4.00 |
| Co₃O₄ | 0 | 0 | 0 |
| MnO₂ | 0 | 0 | 0 |
| SnO₂ | 0.11 | 0.11 | 0.11 |
| Dₖ@10 GHz | 4.54 | 4.47 | 4.45 |
| D_{f}@10 GHz | 0.0025 | 0.0025 | 0.0025 |

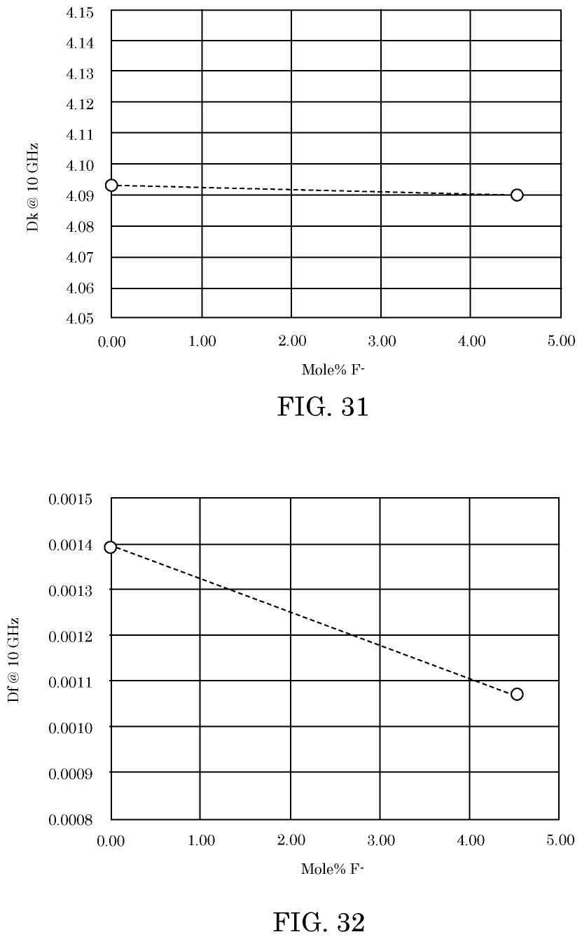

Fluorine is a halide element that has been used in glass melting to lower the viscosity of a glass melt as well as help with fining of a glass melt. When substituted for B₂O₃ it also provides a lowering of D_{f} while maintaining substantially the same Dₖ as the base glass. Table 15 shows three alkaline earth alumino-borosilicate glass compositions with additions of F— for B₂O₃ and data for Dₖ and D_{f} at 10 GHz. FIG. 31 and FIG. 32 show Dₖ and D_{f} as a function of mole % F— added as a replacement for B₂O₃, respectively. The data clearly show Dₖ remains substantially the same for a glass with 4.5 mole % F— in place of B₂O₃, while D_{f} decreases. This not only helps lower the D_{f} of the glass, but it also helps lower the B₂O₃ content of the glass, thereby reducing melting defects such as silica knots, and lowers the viscosity of the glass melt, making it easier to melt the glass, as it requires less energy for melting. The F— may also help with reducing bubbles or seeds due to inadequate fining of the glass.

TABLE 15

| Glass | GS94 | GS95 | GS96 |
|---|---|---|---|
| SiO₂ | 71.16 | 70.28 | 69.68 |
| Al₂O₃ | 5.32 | 5.20 | 5.20 |
| B₂O₃ | 19.03 | 17.77 | 16.15 |
| K₂O | 0 | 0 | 0 |
| Na₂O | 0 | 0 | 0 |
| MgO | 3.26 | 3.24 | 3.28 |
| CaO | 1.15 | 1.13 | 1.10 |
| F | 0 | 2.30 | 4.51 |
| SnO₂ | 0.09 | 0.09 | 0.08 |
| Dk@10 GHz | 4.09 | | 4.09 |
| Df@10 GHz | 0.0014 | | 0.0011 |

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A method of making a glass article, comprising
forming a molten glass, the molten glass undergoing spinodal decomposition to produce a phase separated molten glass comprising a first phase, a second phase, and a total SiO₂ content in a range from about 59 mol % to about 69 mol % and a B₂O₃ content in a range from about 9 mol % to about 20 mol %;
drawing the phase separated molten glass into a glass sheet; and
exposing the glass sheet to a first acid solution at a temperature between about 60° C. to about 95° C. for about 16 hours to about 24 hours to remove at least a portion of the second phase from the glass sheet and obtain a porous glass sheet comprising a total silica content greater than about 95 mol %.

2. The method of claim 1, wherein an open porosity of the porous glass sheet is greater than about 28%.

3. The method of claim 1, wherein the first acid solution comprises about 5 wt % to about 40 wt % of at least one of HCl, H₂SO₄, HNO₃, HF, or H₃PO₄.

4. The method of claim 3, wherein the first acid solution comprises HCl.

5. The method of claim 4, wherein the first acid solution comprises about 5 wt % HCl.

6. The method of claim 1, wherein the first acid solution comprises about 5 wt % to about 40 wt % of at least one of citric acid or acetic acid.

7. The method of claim 1, further comprising heating the porous glass sheet to a temperature between about 500° C. to about 700° C. for about 45 minutes to about 75 minutes.

8. The method of claim 1, further comprising heating the porous glass sheet to a temperature between about 900° C. to about 1100° C. for about 1 hour to about 24 hours to consolidate the porous glass sheet and obtain a consolidated glass sheet, the consolidated glass sheet comprising a dielectric constant Dₖ less than about 4.0 when measured at 10 GHz using a split post dielectric resonator.

9. The method of claim 8, wherein Dₖ is less than about 3.5 when measured at 10 GHz using the split post dielectric resonator.

10. The method of claim 8, wherein the consolidated glass sheet comprises a loss tangent D_{f} less than about 0.0075 when measured at 10 GHz using the split post dielectric resonator.

11. The method of claim 8, wherein the consolidation temperature is equal to or greater than about 1000° C.

12. The method of claim 11, wherein the consolidated glass sheet comprises a loss tangent D_{f} less than about 0.003 when measured at 10 GHz using the split post dielectric resonator.

13. The method of claim 12, wherein D_{f} is less than about 0.001 when measured at 10 GHz.

14. The method of claim 1, further comprising exposing the porous glass sheet to a second acid solution comprising HF for about 1 minute to about 15 minutes prior to the heat treating.

15. The method of claim 1, wherein the drawing the molten glass into the glass sheet comprises flowing the molten glass over converging forming surfaces of a forming body as separate streams of molten glass, the separate streams of molten glass joining along a bottom edge of the forming body.

16. The method of claim 1, wherein the drawing the molten glass into the glass sheet comprises flowing the molten glass from a slot positioned in a bottom of a vessel.

17. A glass article made by the method of claim 1.

18. A glass article made by the method of claim 8.

19. A glass article comprising a spinodally decomposed glass including a first phase and a second phase, the glass comprising on an oxide basis:
SiO₂ from about 57 mol % to about 70 mol %
Al₂O₃ from about 4.7 mol % to about 10.5 mol %
B₂O₃ from about 11.2 mol % to about 15.2 mol %
ZnO from about 1.2 mol % to about 7.4 mol %; and
one or more alkaline earth oxides (RO) totaling from about 3.7 mol % to about −20 mol %, wherein RO is selected from MgO, CaO, SrO, and BaO.

20. The glass article of claim 19, wherein the glass comprises SnO from about 0.09 mol % to about 0.15 mol %.

21. The glass article of claim 19, wherein the glass comprises MgO from about 1.5 mol % to about 9.6 mol %.

22. The glass article of claim 21, wherein MgO/ZnO is from about 0 to about 3.7.

23. The glass article of claim 21, wherein B₂O₃/ZnO is from about 1.6 to about 12.6

24. The glass article of claim 19, wherein a dielectric constant Dₖ of the glass is from about 4.5 to about 6.3 when measured at 10 GHz using a split post dielectric resonator.

25. The glass article of claim 24, wherein a loss tangent D_{f} of the glass is from about 0.002 to about 0.005 when measured at 10 GHz using the split post dielectric resonator.

26. The glass article of claim 19, further comprising at least one of La₂O₃, Y₂O₃, or Li₂O in an amount less than about 3.0 mol %.

27. The glass article of claim 19, further comprising CaO from about 0.05 mol % to about 4.8 mol %.

28-44. (canceled)
